(19) United States
(12) Patent Application Publication
(10) Pub. No.: US 2022/0391560 A1
(43) Pub. Date: Dec. 8, 2022

(54) SYSTEM AND METHOD FOR DESIGNING AND FABRICATING PHYSICAL PRODUCTS FOR INDUSTRIAL PURPOSES

(71) Applicant: Naya Studio, Inc., Allston, MA (US)

(72) Inventors: Saad Rajan, Boston, MA (US); Vivek Haligeri Veerana, Boston, MA (US)

(21) Appl. No.: 17/805,400

(22) Filed: Jun. 3, 2022

Related U.S. Application Data
(60) Provisional application No. 63/196,505, filed on Jun. 3, 2021.

(51) Int. Cl. G06F 30/20

(52) U.S. Cl. CPC G06F 30/20; G06Q 50/04

(57) ABSTRACT

The present disclosure is directed to a system and method of designing, fabricating, and shipping comprising the steps: providing an electronic platform; prompting a user to describe an article on a canvas on said electronic platform; assigning a designer to generate a design of said article; generating said design of said article by said designer based on said description provided by said user; assigning a consultant to improve said design from a fabrication standpoint; improving said design from a fabrication standpoint; assigning a fabricator; fabricating said article by said fabricator; assigning a deliverer; delivering said article to said user.

### CROSS-REFERENCE TO RELATED APPLICATIONS

This non-provisional application claims the benefit of and priority to U.S. Provisional Patent Application No. 63/196,505, filed on Jun. 3, 2021, by inventor Saad Rajan and Vivek Haligeri Veerana, the contents of which are expressly incorporated herein by this reference.

### BACKGROUND

Computers have revolutionized a number of industries, allowing for automation on a wide scale. However, an individual's input in style may often be difficult for a computer system to grasp and properly integrate. Accordingly, many processes still require the input of multiple humans to achieve desired results.

For example, when designing new of novel industrial designs most of the steps require discussing ideas with a particular specialized individual for the various stages. Some of these stages include designing, design briefing, sketching, modeling, shop drawings, design for manufacturing, quality control, fabricating, shipping, and delivery. These stages are generally disjointed and require a great deal of coordination by a human.

Similar difficulties are faced in a number of industrial design fields. The common problem is often that a single individual, or company, does not have all the skills required to take an idea all the way through from conception to delivery.

Thus, what is needed is a system and method that allows users to create desired physical products, including industrial designs furniture, and facilitate design, evaluation, fabrication, and delivery of the products.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

One embodiment may be a method of designing, fabricating, and shipping an article of manufacture, comprising the steps providing an electronic platform; prompting a user to determine one or more design characteristics of the article of manufacture on the electronic platform, assigning a designer to generate a design of the article, generating the design of the article by the designer based on the design characteristics provided by the user, assigning a consultant to improve the design from a fabrication standpoint, assigning a fabricator, and fabricating the article of manufacture by the fabricator. The method of designing, fabricating, and shipping an article of manufacture where the design characteristics may comprise a design brief, a sketch, a budget, dimensions, and one or more comments to generate a design brief of the article of manufacture on the electronic platform. The design brief may allow the user to enter information relating to where the article of manufacture is intended to be placed, what the article of manufacture will be, what the article of manufacture will be used for, and how many copies of the article of manufacture is desired by the user. The sketch may allow the user to provide one or more impressions of what the article of manufacture will be when completed. The one or more impressions may comprise one or more existing constructs, one or more free-hand sketches, one or more marked up illustrations, and combinations thereof. The budget may comprise one or more monetary figures. The dimensions may comprise a length, a width, and a height of the article of manufacture. The one or more comments may comprise guidance as to desired features of the article of manufacture. The designer is assigned by identifying one or more characteristics of the article of manufacture and comparing the characteristics with one or more attributes of the designer to determine compatibility. The consultant is assigned by comparing the design with one or more attributes of the consultant to determine compatibility. The method of designing, fabricating, and shipping an article of manufacture may comprise the step: improving the design of the article of manufacturer from a fabrication standpoint by the consultant. The fabricator is assigned by comparing the design with one or more attributes of the fabricator to determine compatibility. The deliverer is assigned by comparing the fabricated article of manufacture with one or more attributes of the consultant to determine compatibility. The method of designing, fabricating, and shipping an article of manufacture may comprise the step: delivering the article to the user by the deliverer.

Another embodiment may comprise a system and method of designing, fabricating, and shipping an article of manufacture, comprising the steps providing an electronic platform; prompting a user to describe an article on a canvas on the electronic platform, assigning a designer to generate a design of the article, generating the design of the article by the designer based on the description provided by the user, assigning a consultant to improve the design from a fabrication standpoint, improving the design from a fabrication standpoint, assigning a fabricator, fabricating the article by the fabricator, assigning a deliverer, and delivering the article to the user.

In accordance with the embodiments disclosed herein, the present disclosure is directed to a system that allows individuals to propose specific constructs and automatically allow service providers to provide their expertise at specific stages to allow for the individual to create a desired construct.

In accordance with the embodiments disclosed herein, there may be provided a system for operating an electronic platform in conjunction with various service providers and machine learning enhancements.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a flow diagram of one embodiment of a platform for designing, fabricating, and delivering custom furniture.

FIG. 2 is a process diagram of a platform for designing, fabricating, and delivering custom furniture.

FIG. 3 is a block diagram of how a platform for designing, fabricating, and delivering custom furniture may interact with other applications.

FIG. 4 is one embodiment of a design brief input screen for use with a platform for designing, fabricating, and delivering custom furniture.

FIG. 5 is one embodiment of an information selection screen for use with a platform for designing, fabricating, and delivering custom furniture may.

FIG. 6 is one embodiment of a sketch input screen for use with a platform for designing, fabricating, and delivering custom furniture.

FIG. 7 is one embodiment of a budget input screen for use with a platform for designing, fabricating, and delivering custom furniture.

FIG. 8 is one embodiment of a dimension input screen for use with a platform for designing, fabricating, and delivering custom furniture.

FIG. 9 is one embodiment of a number of articles selection input screen for use with a platform for designing, fabricating, and delivering custom furniture.

FIG. 10 is one embodiment of a furniture style input screen for use with a platform for designing, fabricating, and delivering custom furniture.

FIG. 11 is one embodiment of a markup input screen for use with a platform for designing, fabricating, and delivering custom furniture.

FIG. 12 is one embodiment of a comment input screen for use with a platform for designing, fabricating, and delivering custom furniture.

FIG. 13 is a series of screenshots of markup on photographs of potential renderings of the custom furniture or article of manufacture.

FIG. 14 is a set of illustrations that show an initial freehand sketch by a user and the eventual product created as a result of using the platform for designing, fabricating, and delivering custom furniture and articles of manufacture.

FIGS. 15A-C are flow diagrams of one method for designing, fabricating, and delivering custom articles of manufacture.

FIG. 16 is a flow diagram of one method for designing, fabricating, and delivering custom articles of manufacture.

FIG. 17 is an illustration of one embodiment of a sketch input screen for use with a platform for designing, fabricating, and delivering custom articles of manufacture.

FIG. 18 is an illustration of one embodiment of a template selection screen for use with a platform for designing, fabricating, and delivering custom articles of manufacture.

FIG. 19 is an illustration of one embodiment of a project overview screen for use with a platform for designing, fabricating, and delivering custom articles of manufacture.

FIG. 20 is an illustration of one embodiment of a project overview screen for use with a platform for designing, fabricating, and delivering custom articles of manufacture.

FIG. 21 is an illustration of one embodiment of a sketch input screen for use with a platform for designing, fabricating, and delivering custom articles of manufacture.

FIG. 22 is an illustration of one embodiment of a render input screen for use with a platform for designing, fabricating, and delivering custom articles of manufacture.

FIG. 23 is an illustration of one embodiment of a render input screen for use with a platform for designing, fabricating, and delivering custom articles of manufacture.

FIG. 24 is an illustration of one embodiment of a project details screen for use with a platform for designing, fabricating, and delivering custom articles of manufacture.

FIG. 25 is an illustration of one embodiment of a sketch input screen for use with a platform for designing, fabricating, and delivering custom articles of manufacture.

FIG. 26 is an illustration of one embodiment of a render input screen for use with a platform for designing, fabricating, and delivering custom articles of manufacture.

FIG. 27 is an illustration of one embodiment of a shipping information screen for use with a platform for designing, fabricating, and delivering custom articles of manufacture.

FIG. 28 is an illustration of one embodiment of a project progress screen for use with a platform for designing, fabricating, and delivering custom articles of manufacture.

FIG. 29 is an illustration of one embodiment of a project estimation screen for use with a platform for designing, fabricating, and delivering custom articles of manufacture.

FIG. 30 is an illustration of one embodiment of a project estimation screen for use with a platform for designing, fabricating, and delivering custom articles of manufacture.

FIG. 31 is an illustration of one embodiment of a designer profile for use with a platform for designing, fabricating, and delivering custom articles of manufacture.

FIG. 32 is an illustration of one embodiment of a project management screen for use with a platform for designing, fabricating, and delivering custom articles of manufacture.

FIG. 33 is an illustration of one embodiment of a project management screen for use with a platform for designing, fabricating, and delivering custom articles of manufacture.

### DETAILED DESCRIPTION OF THE ILLUSTRATIVE EMBODIMENTS

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware embodiments. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

In various implementations, the platform may be configured to send and receive messages to other platforms, electronic communication devices, and the like.

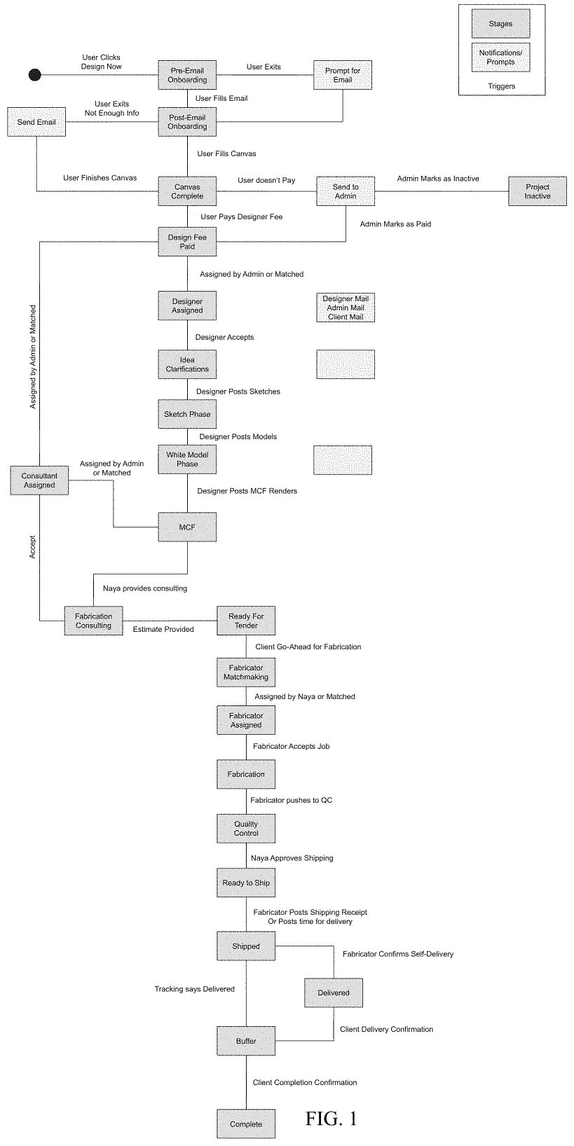

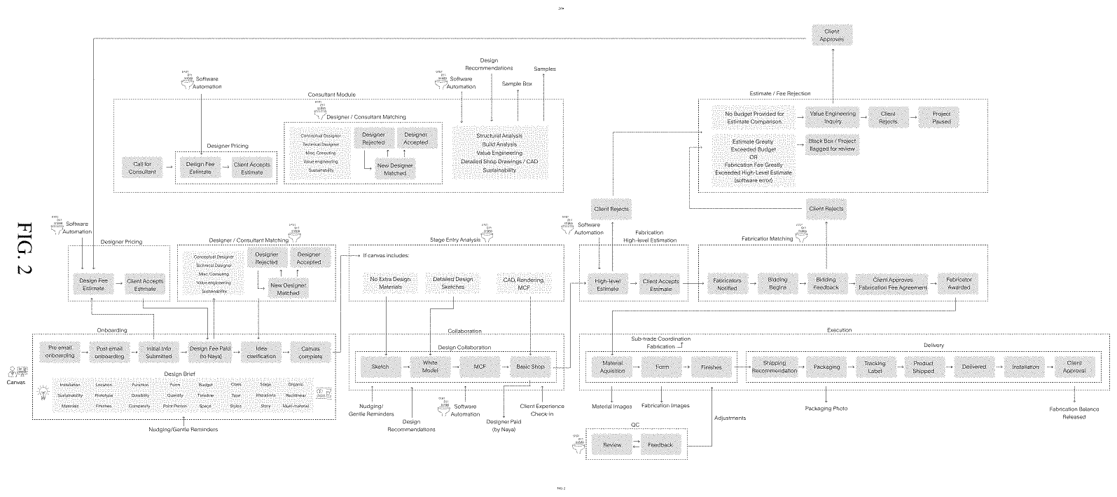

FIG. 1 is a flow diagram of one embodiment of a platform for designing, fabricating, and delivering custom furniture. As shown in FIG. 1, the steps may comprise pre-email onboarding, post email onboarding, canvas completion, paying a design fee, assigning a designer, clarifying ideas, sketching the design, white model phase, assigning a consultant, fabrication consulting, fabricator matchmaking, assigning the fabricator, fabrication, quality control, shipping, and delivery. In some embodiments, machine learning may be utilized to increase efficiency and quality of each step performed.

For example, during the onboarding process, various questions may be presented to the user, and subsequent questions may be generated or asked based on answers to prior questions. In some embodiments, the questions may be presented to the user through a chat box like interface, such that the process of gathering information via questions is dynamic and appears to the user as a conversation rather than interrogation. In some embodiments, machine learning may be used to learn how users generally answer questions, and which additional questions become more or less relevant based on these responses. In some embodiments convolutional neural networks may be used to identify objects in image uploads. In some embodiments, NLP may be used to identify design features and elements based on text or other written material that users post.

During the onboarding process, a stage entry analysis may be performed to determine the status and stage that the project is in. CNN and NLP May be utilized to detect design features uploaded by the user, including determining whether images are sketches, renders, or shop drawings. The platform may also determine if dimensions, shipping location, and material/finish/construction are provided. Based on the status and stage that the project is in, the platform may make specific recommendations as to subsequent steps.

During the onboarding process, design recommendations may be automatically offered by the platform based on information collected about the project. Information collected may include comments, fabrication techniques used, materials suggested, and other information.

At any stage during the process, the platform may generate a cost estimate based on data available, which may include past experiences.

In a preferred embodiment, individuals assigned to the project by the platform may be matched via matchmaking criteria.

In a preferred embodiment, the designer may be assigned by a designer matchmaking module. The designer matchmaking module may use an algorithm to find and match specific designers for the project. In some embodiments, the project may be assigned various criteria, which may be matched with designer profiles. Criteria may include location, budget, style, commercial, residential, materials, timeline, availability of designer, and other factors. In one embodiment, the designer matchmaking module may calculate a weighted euclidean distance between project criteria and designer information in order to suggest or assign specific designers to specific projects. In some embodiments, the project may be offered to designers based on the matchmaking module, and may be offered to subsequent designers if a selected designer declines to take the project. If the matchmaking module is unable to find a designer to assign, the project may be waitlisted.

In a preferred embodiment, the fabricator may be assigned by a fabricator matchmaking module. The fabricator matchmaking module may use an algorithm to find and match specific fabricators for the project. In some embodiments the project may be assigned various criteria, which may be matched with fabricator profiles. Criteria may include location, budget, style, commercial, residential, materials, timeline, availability of fabricator, and other factors. In one embodiment, the fabricator matchmaking module may calculate a weighted euclidean distance between project criteria and fabricator information in order to suggest or assign specific fabricators to specific projects. In some embodiments, the project may be offered to fabricators based on the matchmaking module, and may be offered to subsequent fabricators if a selected fabricator declines to take the project. If the matchmaking module is unable to find a fabricator to assign, the project may be waitlisted and administrators may be notified. In some embodiments, the cost may be determined by an auto estimation tool or manually.

In some embodiments, like quality control or quality assurance protocol may be implemented. The quality control quality assurance protocol may comprise structural and build analysis, as well as feasibility of fabrication of a proposed design. In some embodiments, 3D photogrammetry may be used to match the final built piece with the 3D design. CNN may be used to check surface and finish for defects.

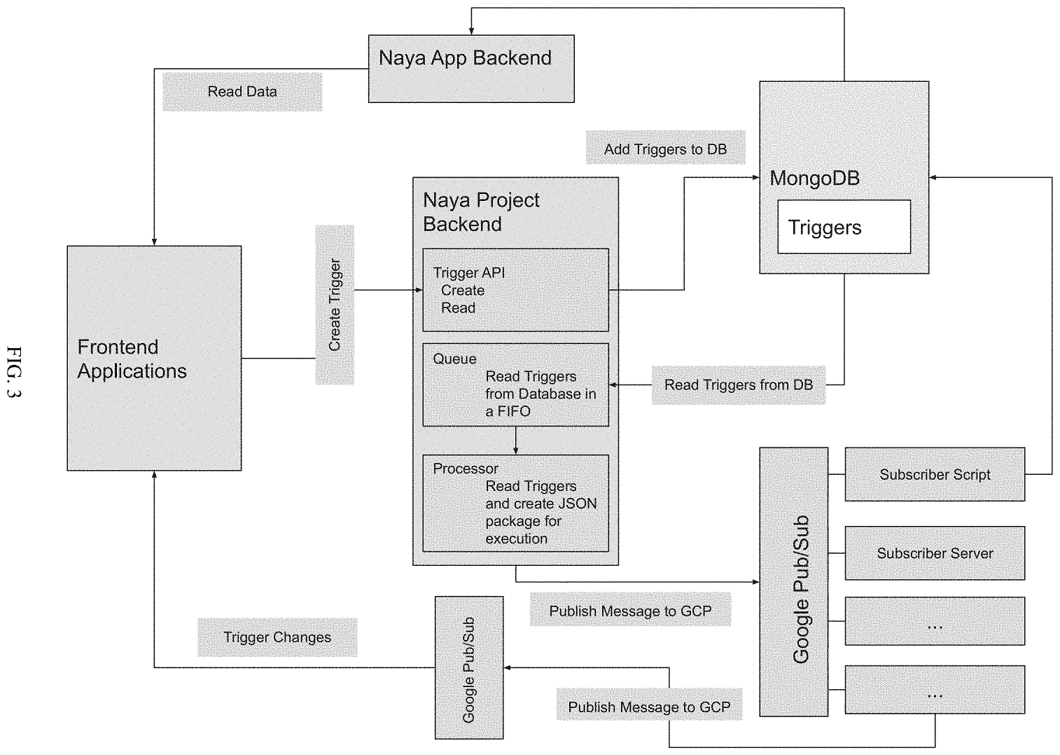

FIG. 2 is a process diagram of a platform for designing, fabricating, and delivering custom furniture. As shown in FIG. 2, the process for designing, fabricating, and delivering custom furniture may comprise distinct stages, comprising an onboarding module, designer pricing module, designer and consultant matching module, stage entry analysis module, collaboration module, fabrication high-level estimation module, fabricator matching module, execution module, quality control module, and estimate/fee rejection module. Each of these distinct stages comprise actions and sets of actions that may be completed and may interact with one or more of the other distinct stages in a linear or non-linear fashion.

For example, onboarding may comprise the steps of pre-email onboarding, post email onboarding, initial information submitted, payment of design fee, idea clarification, and canvas completion.

After the user submits a design by submitting one or more design characteristics of a physical product, such as an article of manufacture, the design may be forwarded to the designer pricing module to generate a design fee estimate. Then, the user has the option to accept or reject the estimate, at which point, the design fee estimate may be paid to the platform. At this stage, a designer may be matched to the project based on the characteristics of the one or more design characteristics and/or one or more attributes of the designer. Then, the user has the option to accept or reject the designer, and if rejected, another designer may be matched. If the designer is accepted, then the designer may work with the user to clarify the idea, and eventually, complete the canvas. In some embodiments, the canvas may reflect the initial information submitted as modified or suggested by the designer.

Then, at the stage entry analysis module may pass the canvas to the collaboration module, and the collaboration module may begin at different stages depending on kind of canvas prepared. The canvas may be analyzed to determine if there are no extra design materials, detailed design sketches, or computer-aided design (CAD)/rendering/materials colors finishes (MCF) files.

The collaboration module may take a sketch, convert it to a white model or digital clay model, then create an MCF, and finally prepare a basic shop based on the MCF. If the canvas is a detailed design sketch, then the process may begin at the white model stage. If the canvas is a CAD/Rendering/MCF, then the process may begin at the basic shop stage. At the basic shop stage, the designer may be paid by the platform and/or the user may receive an experience check-in to determine their level of satisfaction.

After the basic shop is prepared, the fabrication high-level estimation module of the platform may generate a high-level estimate for fabrication. The high-level estimate for fabrication may be determined automatically based on the basic shop. If the user rejects the high-level estimate for fabrication, the estimate/fee rejection module may be utilized. If the high-level estimate for fabrication is accepted by the user, then fabricators may be notified, and the fabricators may begin bidding on the project. After receiving bidding feedback, the user may approve or reject a fabrication fee agreement. If the user accepts the fabrication fee agreement, then the fabricator is awarded the project, and the execution stage may begin. At this point, the fabricator may acquire materials, form the article of manufacture, and finish the article, which may include adjustments such as feedback and review. Once the fabricator has completed fabricating the article of manufacture, a shipping recommendation may be made. In one embodiment, the shipping recommendation may be automatically generated by the platform pursuant to shipping qualities of the article of manufacture and requirements of the recipient. Once a shipping recommendation is made, the article of manufacture may be packaged, affixed with a tracking label, shipped, delivered, installed, and approved by the user.

In a preferred embodiment, assigning the designer, consultant, fabricator, shipper, deliverer, and installer may each be automatically recommended or assigned based on a plurality of factors and information available to the platform.

For example, the designer may be assigned by identifying one or more characteristics of the article of manufacture as described by the user and comparing those characteristics with one or more attributes of the designer to determine compatibility. The consultant may be assigned by comparing the design with one or more attributes of the consultant to determine compatibility. The fabricator may be assigned by comparing the design with one or more attributes of the fabricator to determine compatibility. The shipper may be assigned by comparing the article of manufacture with one or more attributes of the shipper to determine compatibility. The deliverer may be assigned by comparing the article of manufacture with one or more attributes of the shipper to determine compatibility. The installer may be assigned by comparing the article of manufacture with one or more attributes of the installer to determine compatibility. The platform may be configured to analyze recommendations made and track approvals or denials, and use that analysis to further improve the recommendation process, such that the platform is able to make recommendations that, over time, are accepted by users at higher rates than previously recommendations.

The estimate/fee rejection module may be utilized in the process when the user rejects an estimation or a fee. In a preferred embodiment, if the estimate/fee rejection module is utilized due to an estimate that exceeded the budget or a fabrication fee that exceeded the high level estimate, then that project may be flagged for separate review to determine why the estimate or fabrication fee exceeded their respective estimates. Because the platform is configured to determine when and why certain estimates were incorrect, the platform may be configured to, in the future, provide more reliable and accurate estimates based on past experience.

Having a good design brief, or submission of one or more design characteristics may be important in allowing the platform to be successful. Other platforms may lack clarity and consistency, which may potentially lead to an excessive number of revisions and long delivery timelines, high material costs, and additional costs later in the process. In some embodiments, the platform may use a chatbot-style interface to allow the client to create the design brief efficiently without leaving information gaps for a designer or fabricator. The platform may use information gained from previous users to enhance a current user's experience, and prompt the current user to enter information that the platform has determined may be beneficial to have at a relatively early stage. In some embodiments, the platform may be integrated into other platforms already in use by translating information inputted into other platforms.

In one embodiment, the user may prepare a design brief, and a designer may convert the design brief into a design concept. Other platforms may have design assets spread out among a multitude of design asset configurations, including sketches, 3D models, renderings, materials, shop drawings, and other assets. This may be a fragmented operation because the series of assets may include emails, redlined text documents, shared online folders, 3D models, and other formats, which may lead to increased confusion and worse outcomes.

In one embodiment, the fabricator may collaborate with the user on the platform itself in order to more efficiently prepare the design concept for fabrication. Other platforms may cause the collaboration between the user and fabricator spread out among a multitude of communication options, including, emails, redlined text documents, shared online folders, 3D models, and other formats, which may lead to increased confusion and worse outcomes.

In the present disclosure, the collaboration platform may allow for centralized feedback regarding design considerations from users, designers, fabricators, deliverers, installers, and other individuals involved in the process of designing, fabricating, and shipping the article of manufacture.

In one embodiment, the present platform may be configured to collect data relating to when and why projects experience difficulties, including when users reject price estimates and price quotes, as well as when and why price estimates end up being significantly higher or lower than price quotes. In some embodiments, additional data analysis may be employed, including various versions of artificial intelligence and/or machine learning protocols. In one embodiment, AI Sherpa, Augmented Design, Generative Design may be used.

In one embodiment, the platform may be integrated into third party applications and processes.

Generally, estimating the cost of manufacturing does not have standard tools. Even experienced makers and fabricators generally spend substantial amounts of time to determine an accurate estimate, and even then, potentially risk losing the project because the parties are unable to align on what is the right price. In some projects, it may take more than twenty hours of work by experienced individuals to determine a rough idea of the costs associated with production.

In one embodiment, the present platform may use an ensemble model comprising linear regression, random forest classifiers and a NN embedding model trained over a proprietary data set containing thousands of data points obtained through prior projects, scraping publicly available data, and partner networks.

In one embodiment, accuracy and explainability of the estimation models may be increased. In some embodiments, the platform may have an RMSE of <10% by using CNNs (which may be configured to pick up on 3D structural complexities), and integrating larger supply chain data (material costs, logistics costs), and other information.

The present platform may also allow for quality control protocols to be implemented in projects that traditionally have difficulty doing so, such as smaller order runs and entities unfamiliar with the quality control process generally. In one embodiment, the present platform allows for quality control measures to be implemented at various steps during the design and fabrication process, rather than simply looking at the final fabricated product for compliance with quality control protocols.

In some embodiments, fabricators may submit a quality control checklist and may upload photographs and videos of finished products for quality control checks.

In some embodiments, the quality control components of the platform may be integrated for use with third party applications.

In some embodiments, the quality control components of the platform may use CNNs to detect common manufacturing defects like welding issues, cracks, scratches, painting drips, color mismatches.

In one embodiment, the platform may utilize a matchmaking algorithm that includes a deterministic model that outputs a sorted list of designers or fabricators based on the project criteria.

In some embodiments, designers and/or fabricators may create a portfolio or profile for themselves on the platform. This portfolio or profile may allow designers and/or fabricators to manage their project assets, and also provide information regarding themselves, which may be used to match them to projects.

In some embodiments, the platform may make recommendations or factor into analysis factors such as sustainability, manufacturing processes (3D printed, traditional joinery), and other factors. In other embodiments, the platform may be configured to be used with additive manufacturing to generate 3d printed objects and order samples.

In some embodiments, artificial intelligence may be used for purposes of material recommendations (based on budgets, dimensions, sustainability and timelines, providing recommendations on materials—Collaborative Filtering and Case-Based Reasoning models), sustainability recommendations (apart from materials, suggestions to manufacturing processes, shipping options and providing insight into carbon footprint), value engineering (Providing different options to reduce the cost—material alternatives, structural alternatives—CNNs combined with collaborative filtering algorithms), and generative design (Using GANs and/or AutoEncoders to automate generation of divergent ideas and concepts.

FIG. 3 is a block diagram of how a platform for designing, fabricating, and delivering custom furniture may interact with other applications.

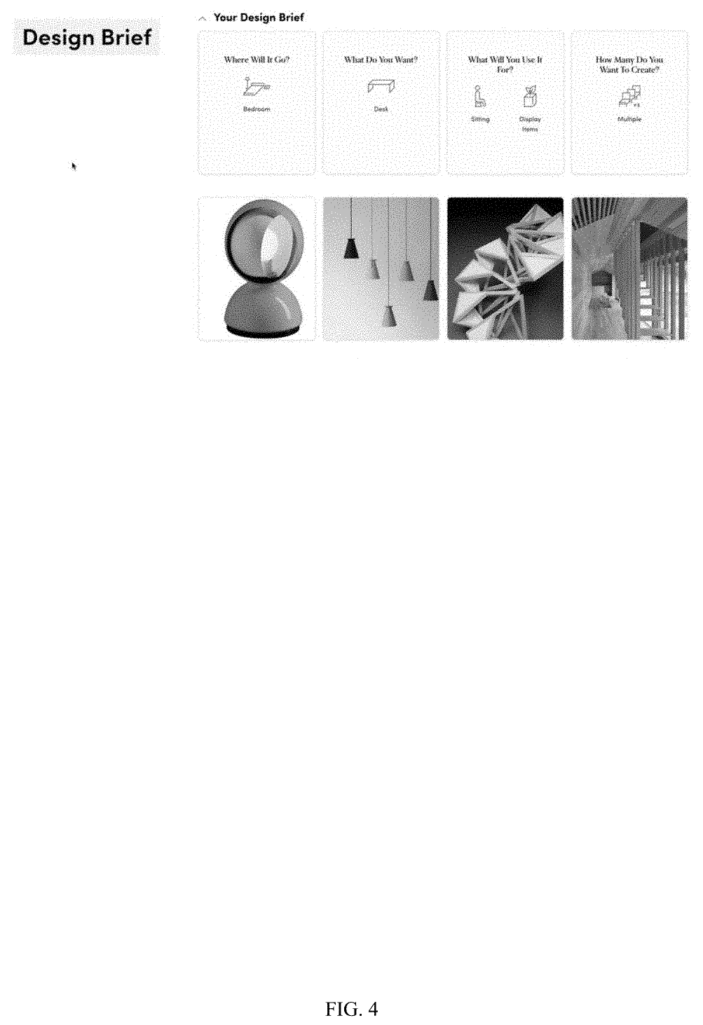

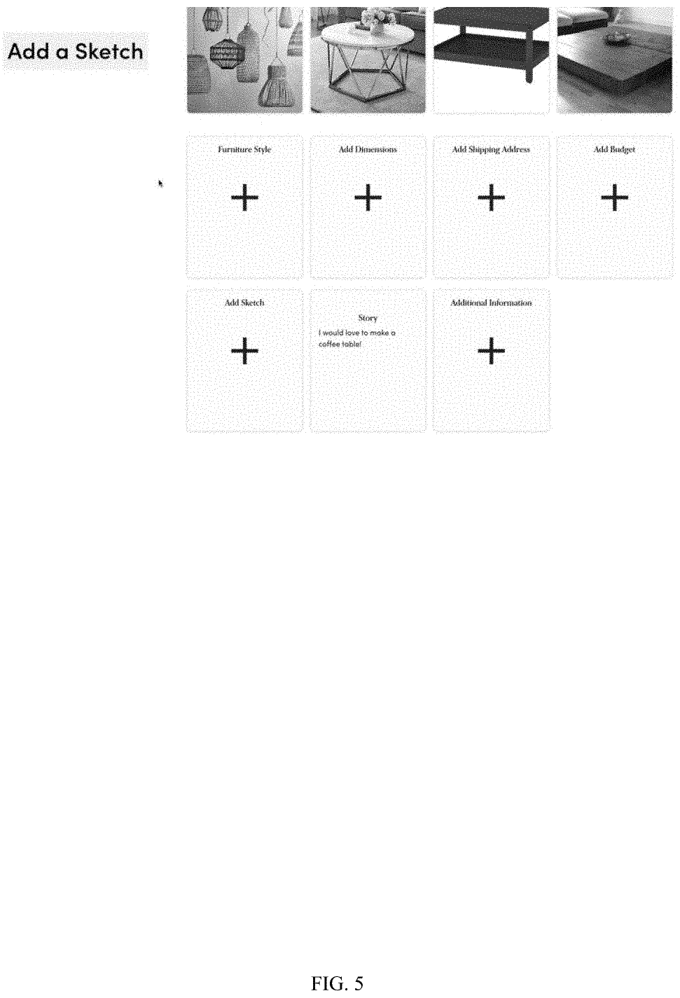

FIG. 4 is one embodiment of a design brief input screen for use with a platform for designing, fabricating, and delivering custom furniture. As shown in FIG. 4, the design brief input screen may allow users to input a design brief information, comprising where the final product will go, what the final product will be, what will the final product be used for, and how many copies of the final product are desired. The user may be prompted to input this information relating to the design brief for additional analysis and processing by selecting one or more of the identified categories.

FIG. 5 is one embodiment of an information selection screen for use with a platform for designing, fabricating, and delivering custom furniture may. As shown in FIG. 5, the information selection screen may allow users to select specific screens or modules into which information may be added, comprising, a furniture style menu, add dimensions menu, add shipping address menu, add budget menu, add sketch menu, story menu, and additional information menu.

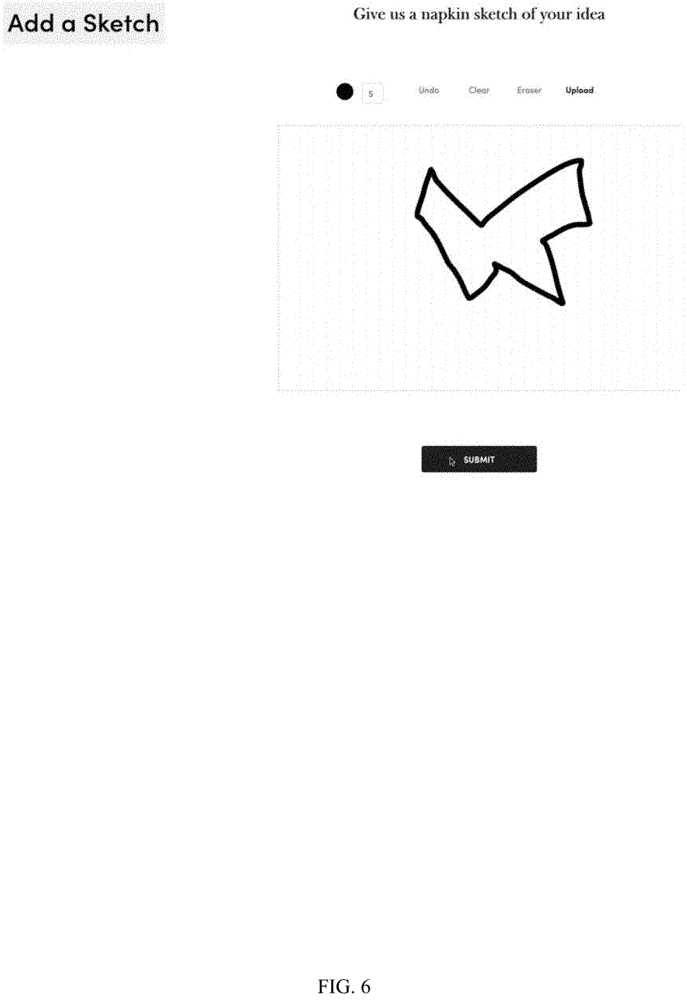

FIG. 6 is one embodiment of a sketch input screen for use with a platform for designing, fabricating, and delivering custom furniture. As shown in FIG. 6, the sketch input screen may allow a user to draw a “freehand” design of what the user would like to create. In this way, the design may be anything that the user may convey, or contain any design elements that the user may desire. One advantage of the sketch input screen is that it may allow a user with rudimentary, or non-existent, design skill to convey to another individual, who would be the designer under the presently disclosed platform, what the desired design may look like. Using the “freehand” design, along with other information provided by the user through the platform, the designer may work to create a design that embodies the idea that the user has, even though the user may lack the specific skills to properly represent the idea.

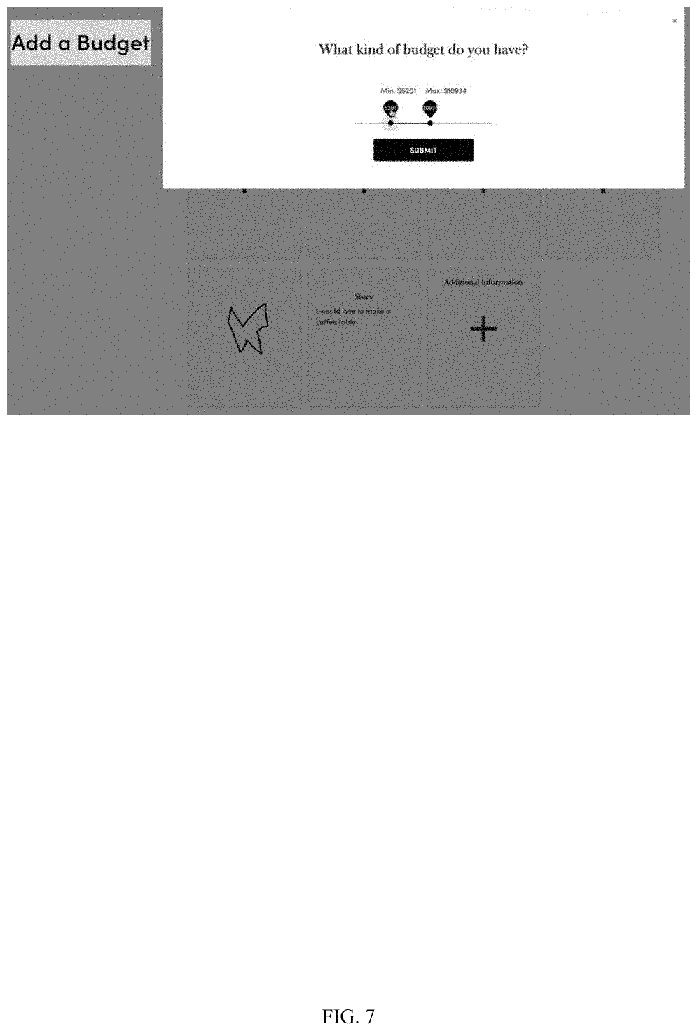

FIG. 7 is one embodiment of a budget input screen for use with a platform for designing, fabricating, and delivering custom furniture. As shown in FIG. 7, the budget input screen may allow the user to input a desired budget, or budget range, for a particular project in the platform.

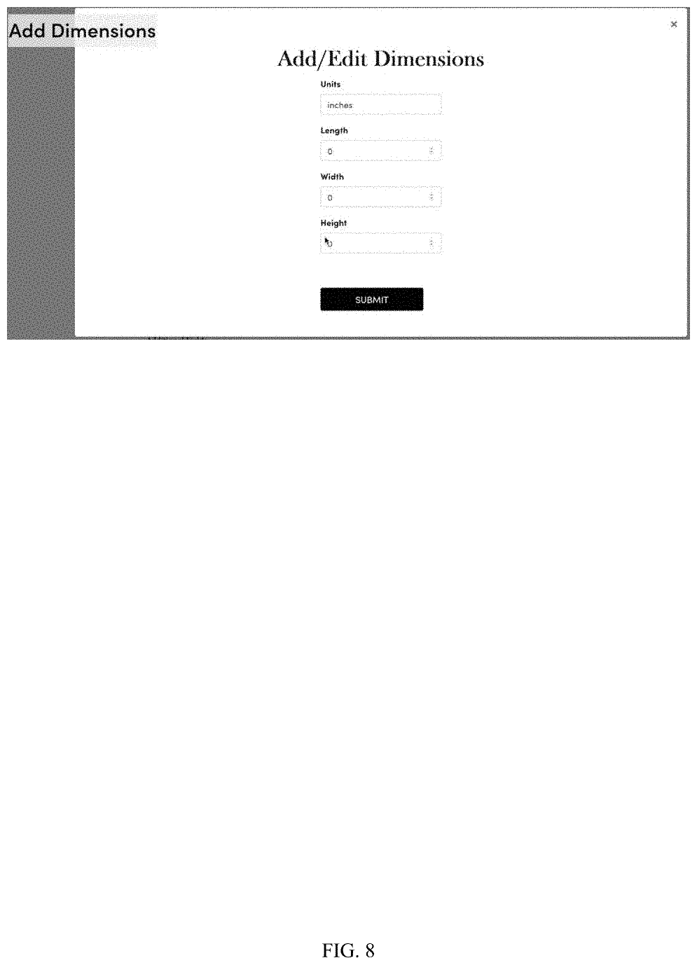

FIG. 8 is one embodiment of a dimension input screen for use with a platform for designing, fabricating, and delivering custom furniture. As shown in FIG. 8, the dimension input screen may allow the user to provide information relating to the custom furniture, or other article of manufacture, such as length, width, and height, including specifying the units used. The units, typically, may be based on imperial or metric measurements. In other embodiments, any type of units may be used.

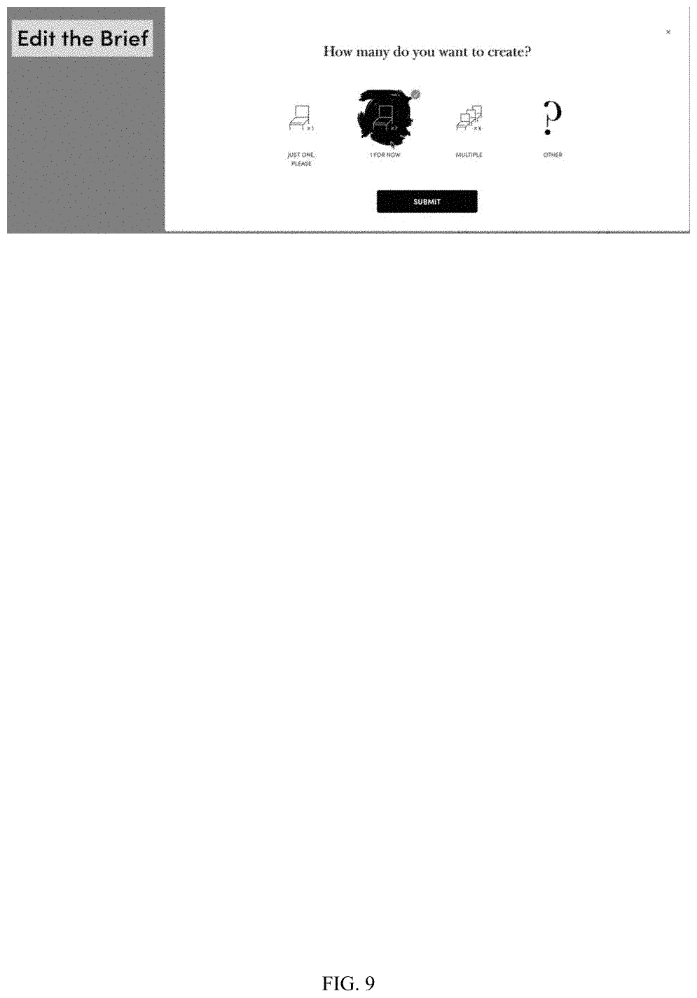

FIG. 9 is one embodiment of a number of articles selection input screen for use with a platform for designing, fabricating, and delivering custom furniture. As shown in FIG. 9, the number of articles selection input screen may allow the user to select whether they would like a single article, a single article with the opportunity to create more later, or multiple articles. In one embodiment, if multiple articles is selected, the user may specifically identify the number of articles desired, or a range thereof.

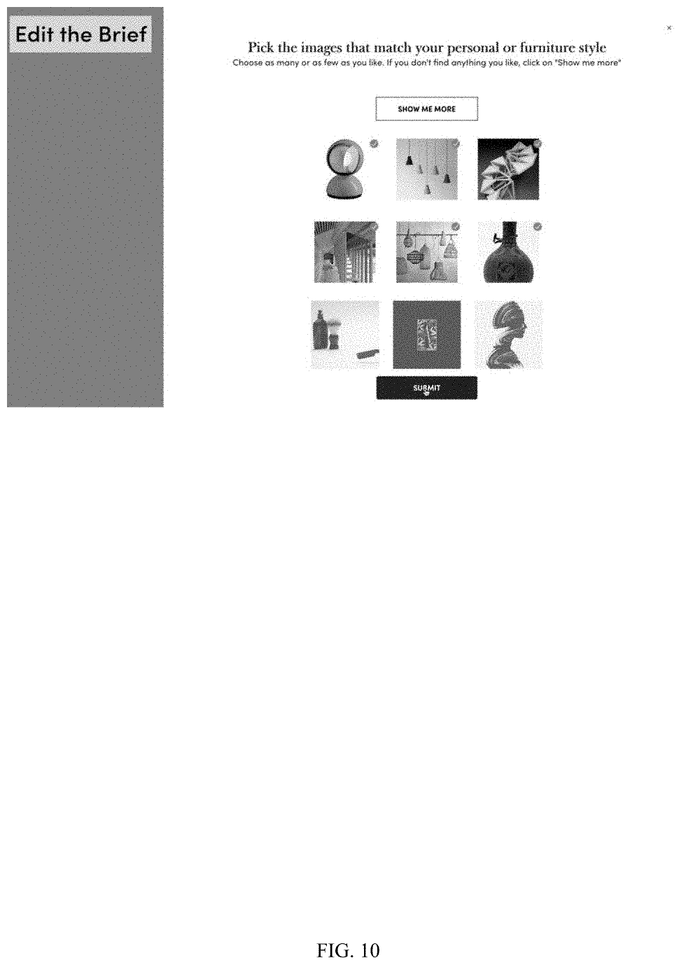

FIG. 10 is one embodiment of a furniture style input screen for use with a platform for designing, fabricating, and delivering custom furniture. As shown in FIG. 10, on the furniture style input screen, the user may select photographs that reflect a style or aspect that the user would like to have reflected in the final fabricated custom furniture or other article of manufacturing.

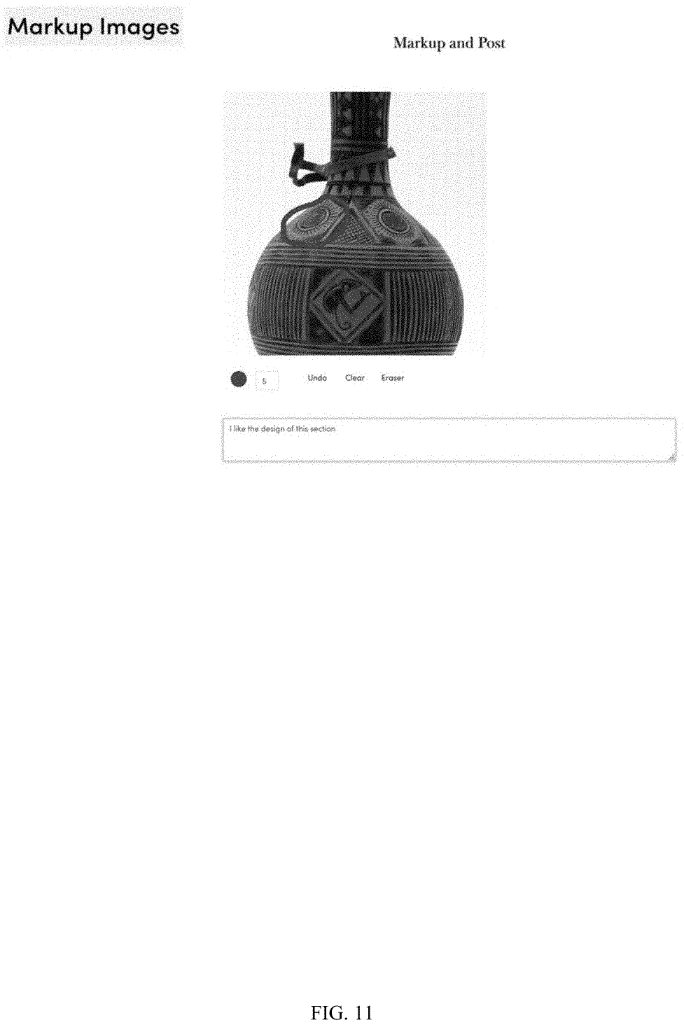

FIG. 11 is one embodiment of a markup input screen for use with a platform for designing, fabricating, and delivering custom furniture. As shown in FIG. 11, the markup input screen may allow users to provide comments and mark up directly on photographs in order to provide the designer with information relating to the user's personal preferences and guidance as to how to design the desired custom furniture or other article of manufacturing. For example, while a vase may not be particularly relevant to a current project, one design element or feature may be relevant, and may be directly identified via markup, such as circling. Additionally, the user may simultaneously provide text comments, such as a sentence, instruction, or command, in addition to the markup to provide further guidance.

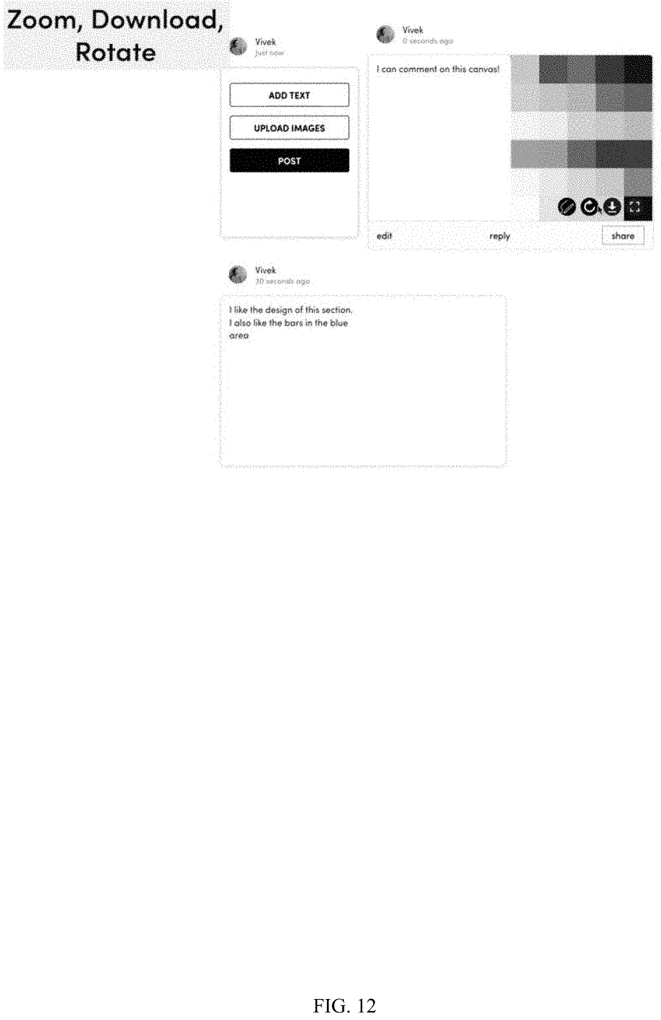

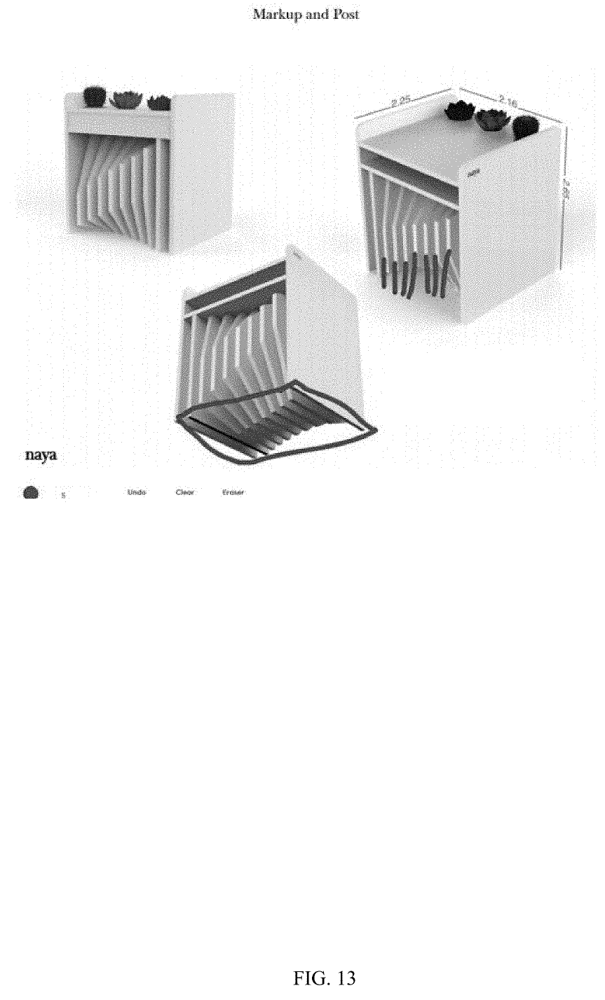

FIG. 12 is one embodiment of a comment input screen for use with a platform for designing, fabricating, and delivering custom furniture. As shown in FIG. 12, users, as well as designers and other individuals using the platform, may be able to comment and add notes, images, or otherwise provide feedback with respect to the canvas.

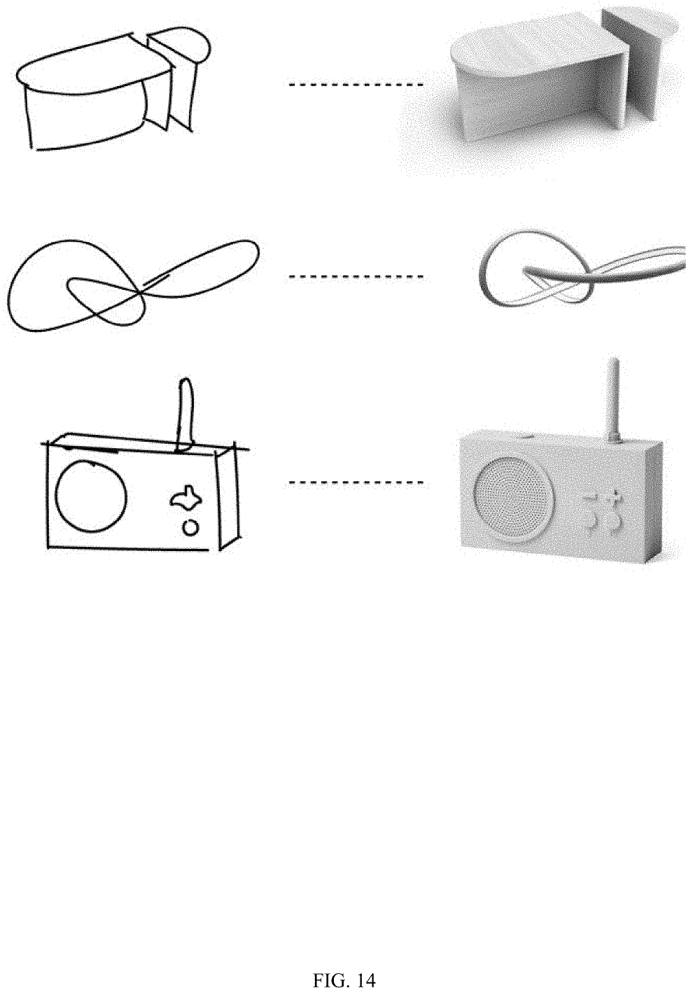

FIG. 13 is a series of screenshots of markup on photographs of potential renderings of the custom furniture or article of manufacture. As shown in FIG. 13, the user may draw lines, circle portions, or otherwise mark up photographs, in progress designs prepared by the designer, or other components in the platform. This user mark up may then be useful for the designer to conduct further revisions to the design to closer approach the user's desired custom furniture or article of manufacture.

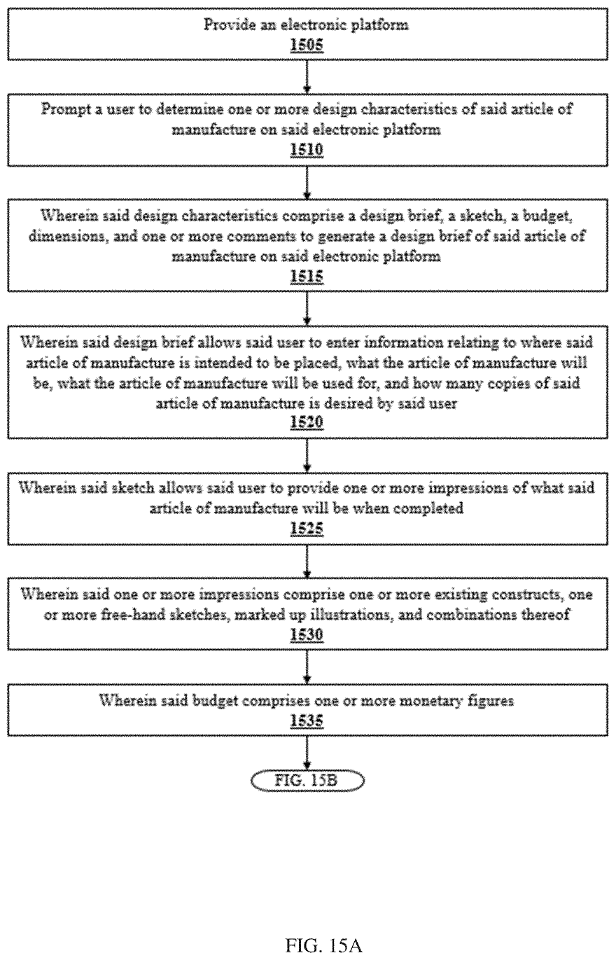

FIG. 14 is a set of illustrations that show an initial freehand sketch by a user and the eventual product created as a result of using the platform for designing, fabricating, and delivering custom furniture and articles of manufacture.

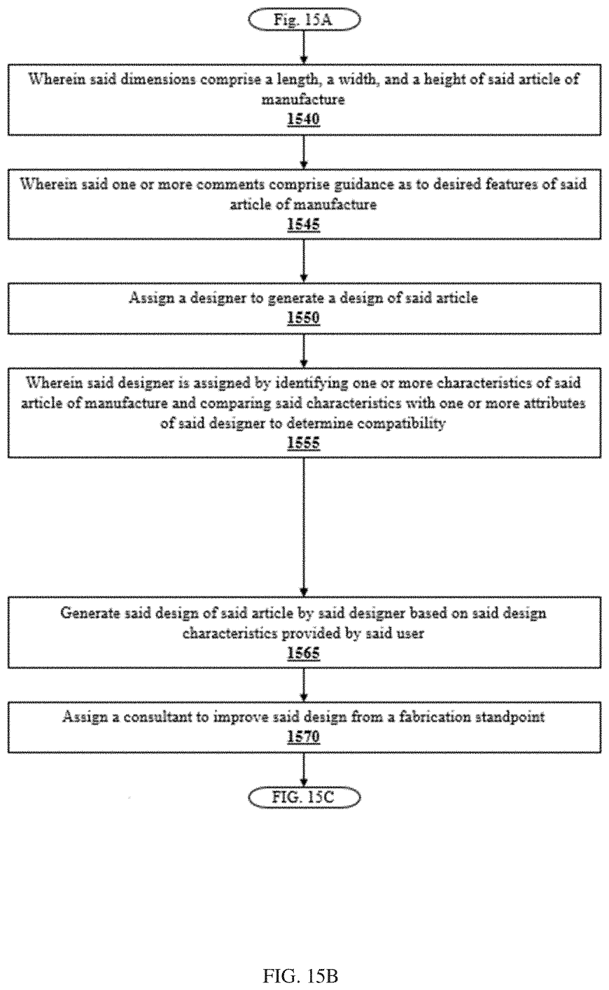

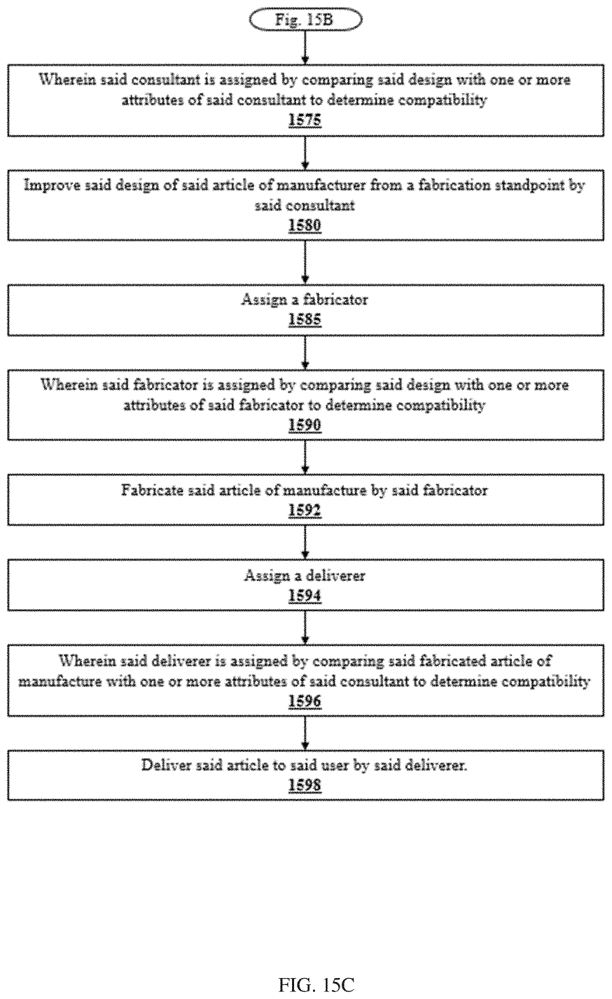

FIGS. 15A-C are flow diagrams of one method for designing, fabricating, and delivering custom articles of manufacture. As shown in FIGS. 15A-C, one method for designing, fabricating, and delivering custom articles of manufacture 1500 may comprise the steps: providing an electronic platform 1505; prompting a user to determine one or more design characteristics of said article of manufacture on said electronic platform 1510; wherein said design characteristics comprise a design brief, a sketch, a budget, dimensions, and one or more comments to generate a design brief of said article of manufacture on said electronic platform 1515; wherein said design brief allows said user to enter information relating to where said article of manufacture is intended to be placed, what the article of manufacture will be, what the article of manufacture will be used for, and how many copies of said article of manufacture is desired by said user 1520; wherein said sketch allows said user to provide one or more impressions of what said article of manufacture will be when completed 1525; wherein said one or more impressions comprise one or more existing constructs, one or more free-hand sketches, one or more marked up illustrations, and combinations thereof 1530; wherein said budget comprises one or more monetary FIG. 1535; wherein said dimensions comprise a length, a width, and a height of said article of manufacture 1540; wherein said one or more comments comprise guidance as to desired features of said article of manufacture 1545; assigning a designer to generate a design of said article 1550; wherein said designer is assigned by identifying one or more characteristics of said article of manufacture and comparing said characteristics with one or more attributes of said designer to determine compatibility 1555; generating said design of said article by said designer based on said design characteristics provided by said user 1565; assigning a consultant to improve said design from a fabrication standpoint 1570; wherein said consultant is assigned by comparing said design with one or more attributes of said consultant to determine compatibility 1575; improving said design of said article of manufacturer from a fabrication standpoint by said consultant 1580; assigning a fabricator 1585; wherein said fabricator is assigned by comparing said design with one or more attributes of said fabricator to determine compatibility 1590; fabricating said article of manufacture by said fabricator 1592; assigning a deliverer 1594; wherein said deliverer is assigned by comparing said fabricated article of manufacture with one or more attributes of said consultant to determine compatibility 1596; delivering said article to said user by said deliverer 1598.

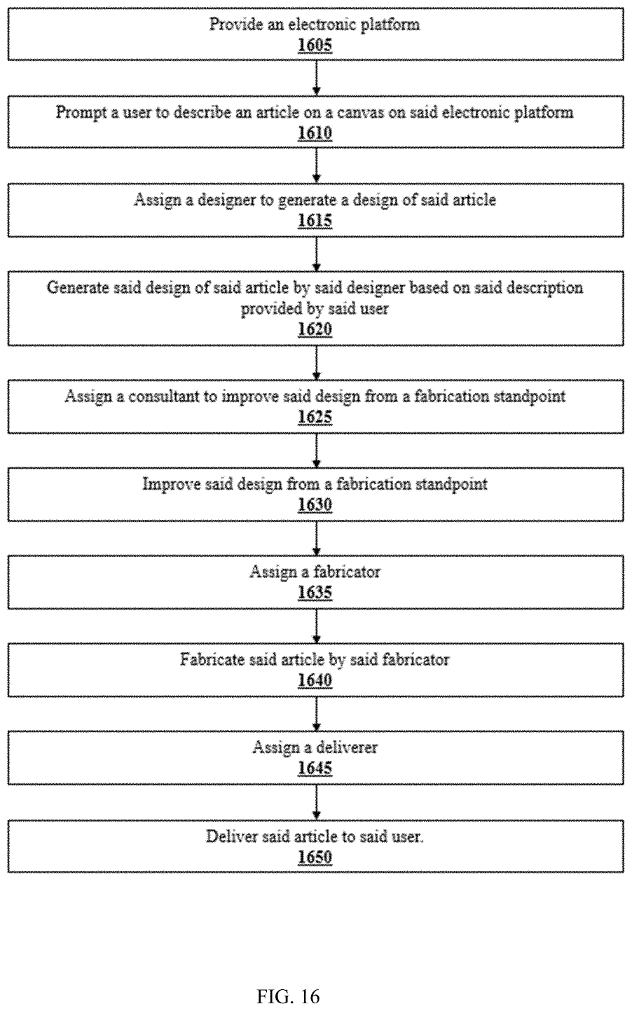

FIG. 16 is a flow diagram of one method for designing, fabricating, and delivering custom articles of manufacture. As shown in FIG. 16, the system and method of designing, fabricating, and shipping an article of manufacture 1600 may comprise the steps:

providing an electronic platform 1605; prompting a user to describe an article on a canvas on said electronic platform 1610; assigning a designer to generate a design of said article 1615; generating said design of said article by said designer based on said description provided by said user 1620; assigning a consultant to improve said design from a fabrication standpoint 1625; improving said design from a fabrication standpoint 1630; assigning a fabricator 1635; fabricating said article by said fabricator 1640; assigning a deliverer 1645; and delivering said article to said user 1650. In some embodiments, the consultant may be assigned to, and may, modify the design, preferably for the purpose of allowing the design to improve the fabrication process. In some embodiments, improving the design from a fabrication standpoint may mean modifying the design to allow the fabrication process to be more efficient, easy, possible with more commonly available tools and implementations, lower cost, or any other modification that makes fabrication better. In one embodiment, improvement from a fabrication standpoint may mean reduction of materials necessary, reducing time to fabricate, allow for different machinery or techniques to be used in the fabrication process, and other things that make the fabrication process easier, more efficient, or otherwise improved.

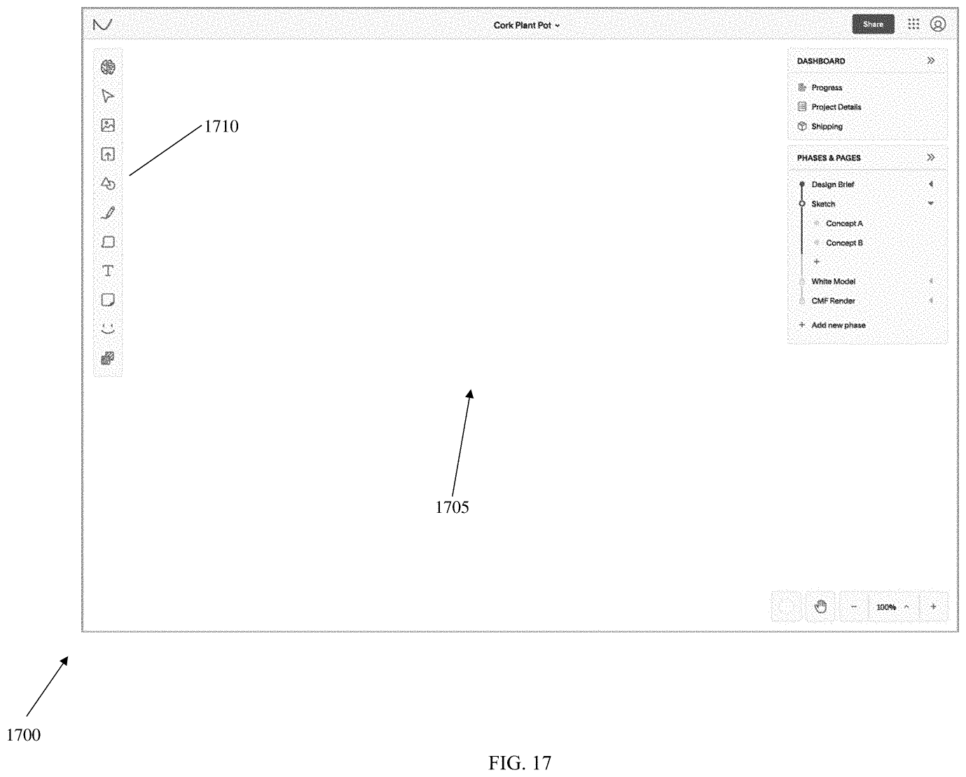

FIG. 17 is an illustration of one embodiment of a sketch input screen for use with a platform for designing, fabricating, and delivering custom articles of manufacture. As shown in FIG. 17, the sketch input screen 1700 may comprise a blank area 1705 and a set of drawing tools 1710, such that the user may use the drawing tools 1710 to draw in the blank area 1705 to represent their design idea.

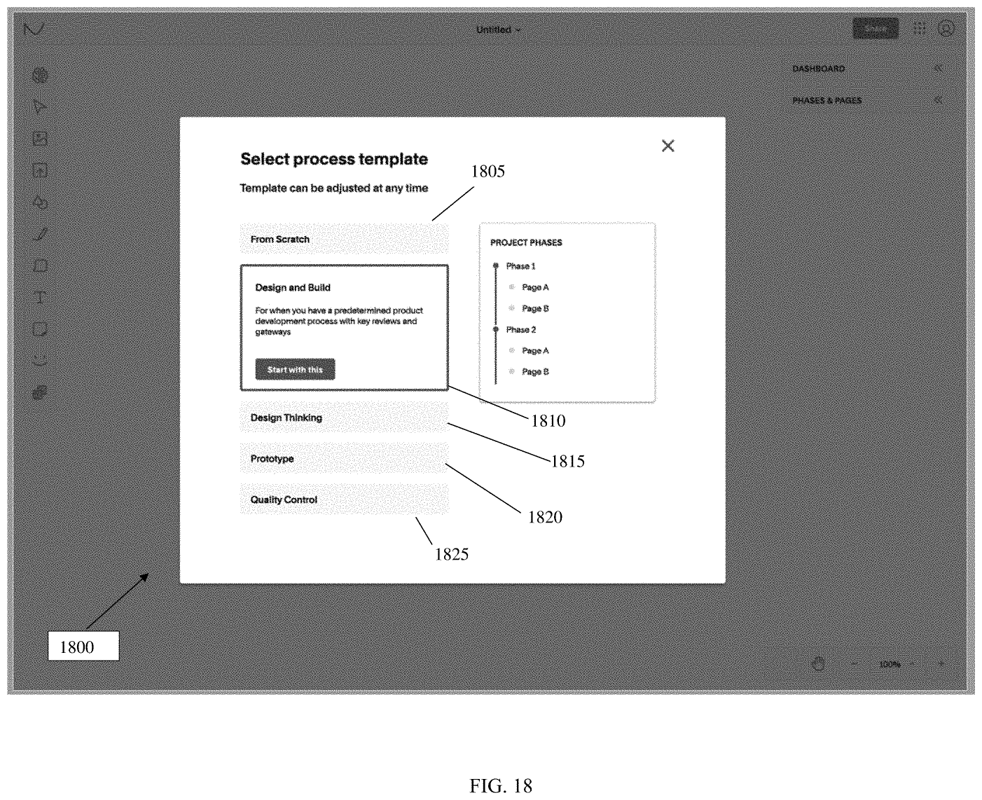

FIG. 18 is an illustration of one embodiment of a template selection screen for use with a platform for designing, fabricating, and delivering custom articles of manufacture. As shown in FIG. 18, the template selection screen 1800 may be configured to guide a user to select how they would like to interact with the platform and what they are trying to accomplish, such as design from scratch 1805, design and build 1810, design thinking 1815, prototype 1820, and quality control 1825.

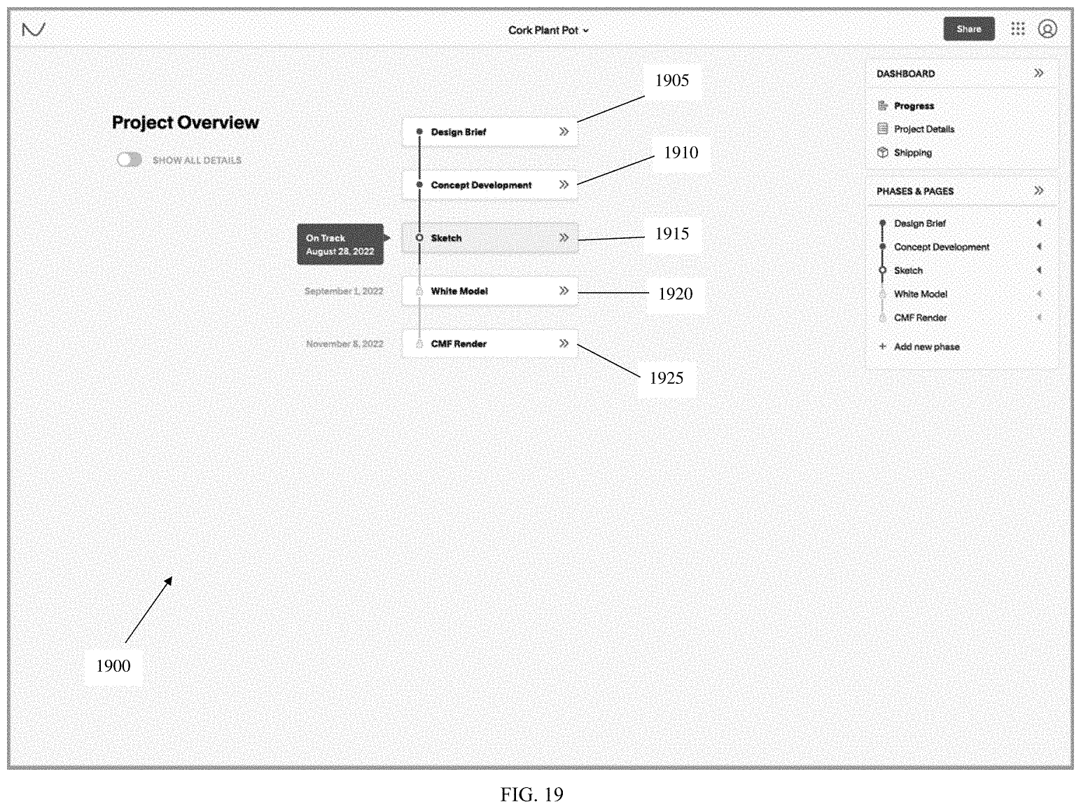

FIG. 19 is an illustration of one embodiment of a project overview screen for use with a platform for designing, fabricating, and delivering custom articles of manufacture. As shown in FIG. 19, the project overview screen 1900 may allow users to navigate the various stages of the design process for an article of manufacture, including design brief 1905, concept development 1910, sketch 1915, white model 1920, and CMF render 1925. This screen may allow a user to monitor the development process of the article of manufacture to determine whether the project is on track or not.

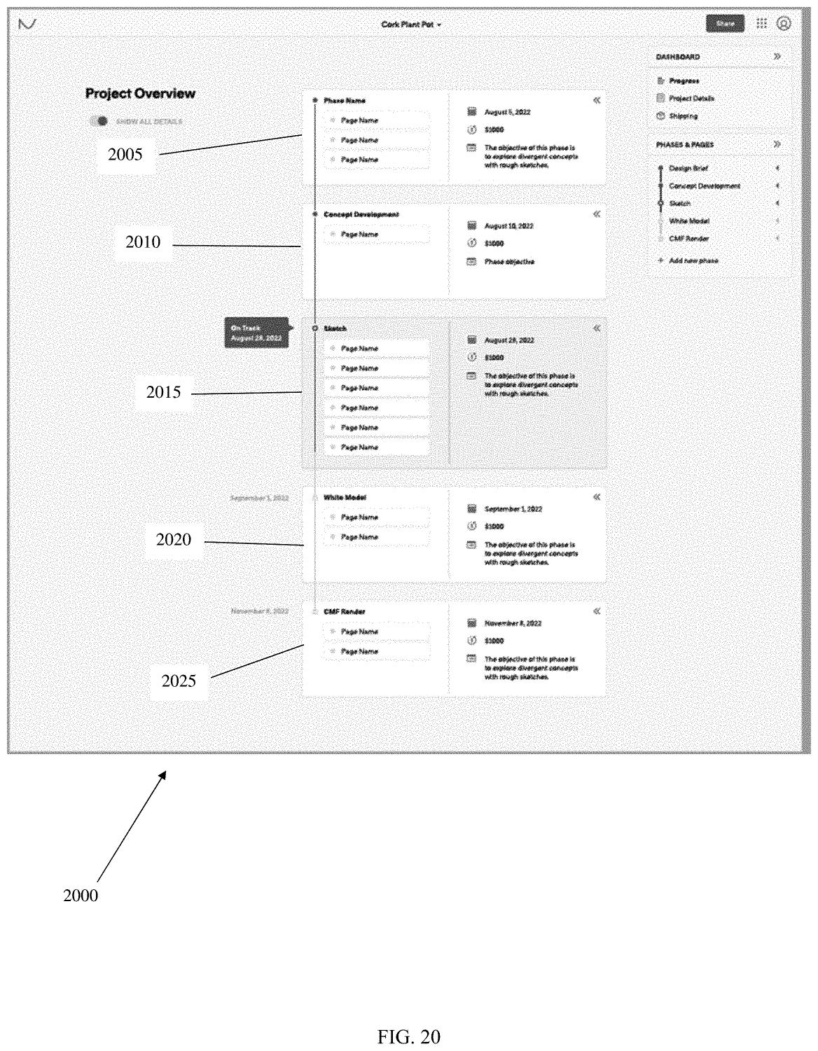

FIG. 20 is an illustration of one embodiment of a project overview screen for use with a platform for designing, fabricating, and delivering custom articles of manufacture. As shown in FIG. 20, the project overview screen 2000 may allow users to navigate the various stages of the design process for an article of manufacture, including design brief 2005, concept development 2010, sketch 2015, white model 2020, and CMF render 2025. This screen may allow a user to monitor the development process of the article of manufacture to determine whether the project is on track or not. As shown, each of the options in the project overview screen may be opened to get more detailed information relating to that option.

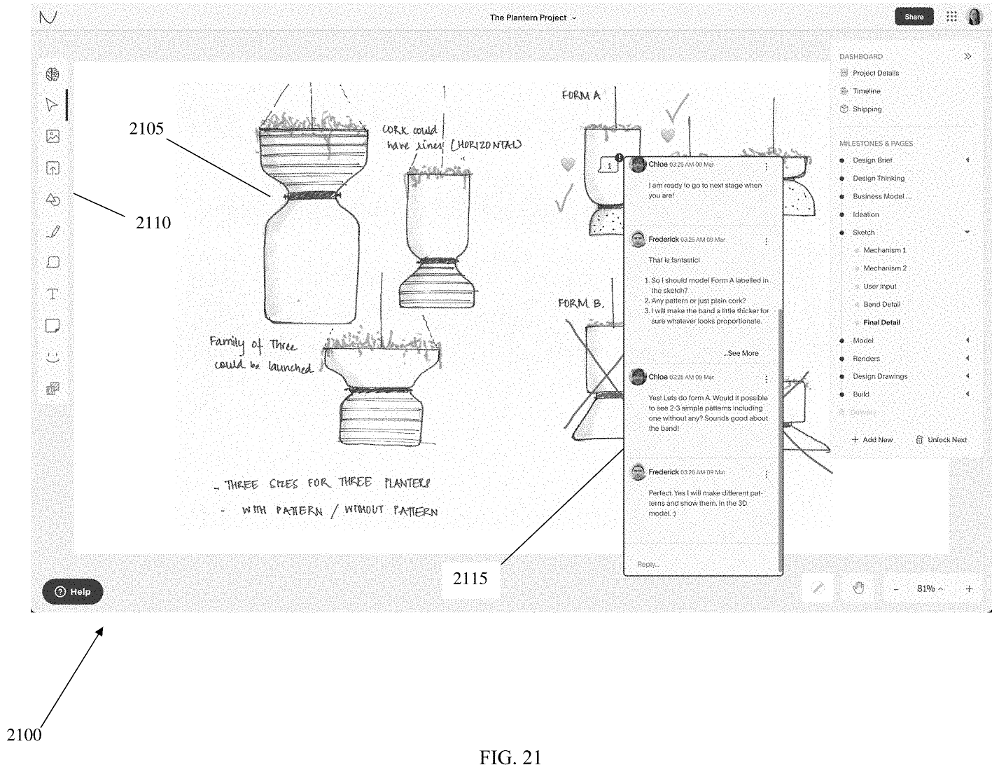

FIG. 21 is an illustration of one embodiment of a sketch input screen for use with a platform for designing, fabricating, and delivering custom articles of manufacture. As shown in FIG. 21, the sketch input screen 2100 may comprise a blank area that has been filled in 2105 and a set of drawing tools 2110, such that the user may use the drawing tools 2110 to draw in the blank area that has been filled in 2105 to represent their design idea. Additionally, the sketch input screen 2100 may comprise a comment portion 2115 configured to allow multiple users to leave comments and collaborate efficiently, directly on the sketch input screen.

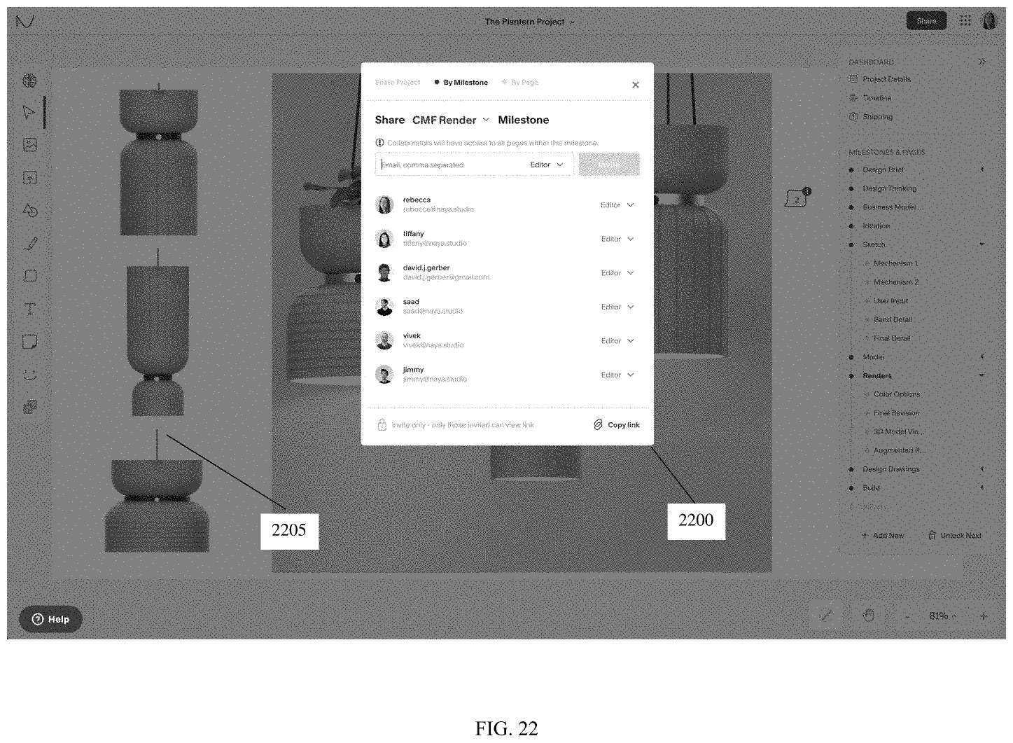

FIG. 22 is an illustration of one embodiment of a render input screen for use with a platform for designing, fabricating, and delivering custom articles of manufacture. As shown in FIG. 22, the render input screen 2200 may comprise a project area 2205 that displays a representation of the rendering of the article of manufacture. The render may also be shared with other individuals, such that other individuals may contribute to the render input screen 2200.

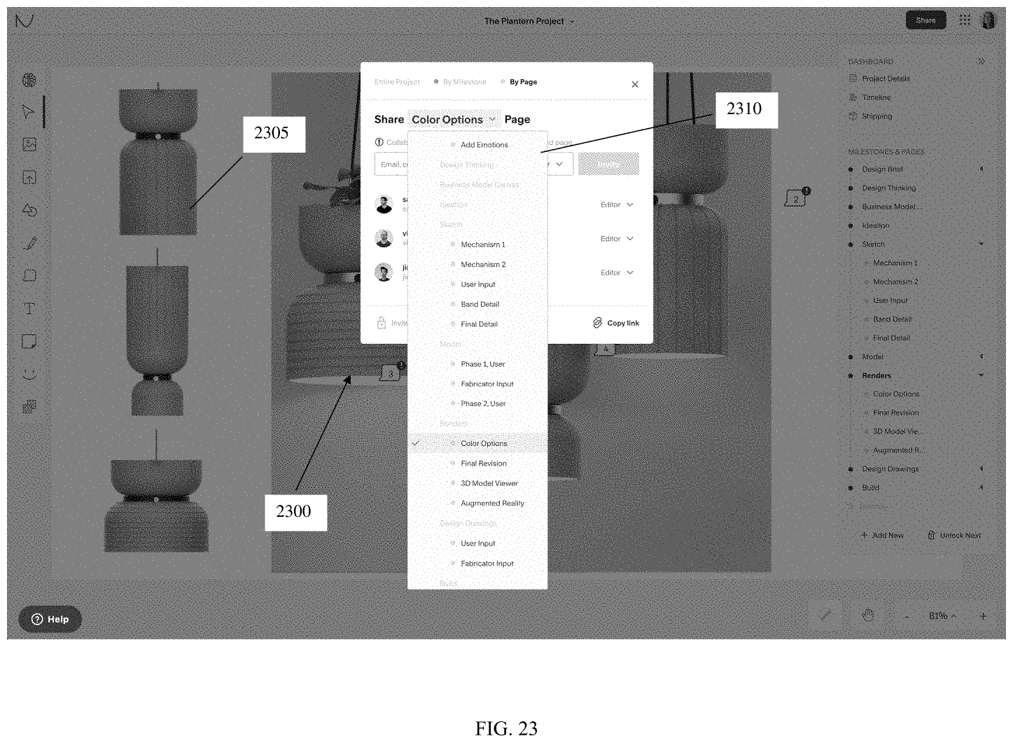

FIG. 23 is an illustration of one embodiment of a render input screen for use with a platform for designing, fabricating, and delivering custom articles of manufacture. As shown in FIG. 23, the render input screen 2300 may comprise a project area 2305 that displays a representation of the rendering of the article of manufacture. The use may utilize a color options menu 2310 to made changes to the color scheme of the render.

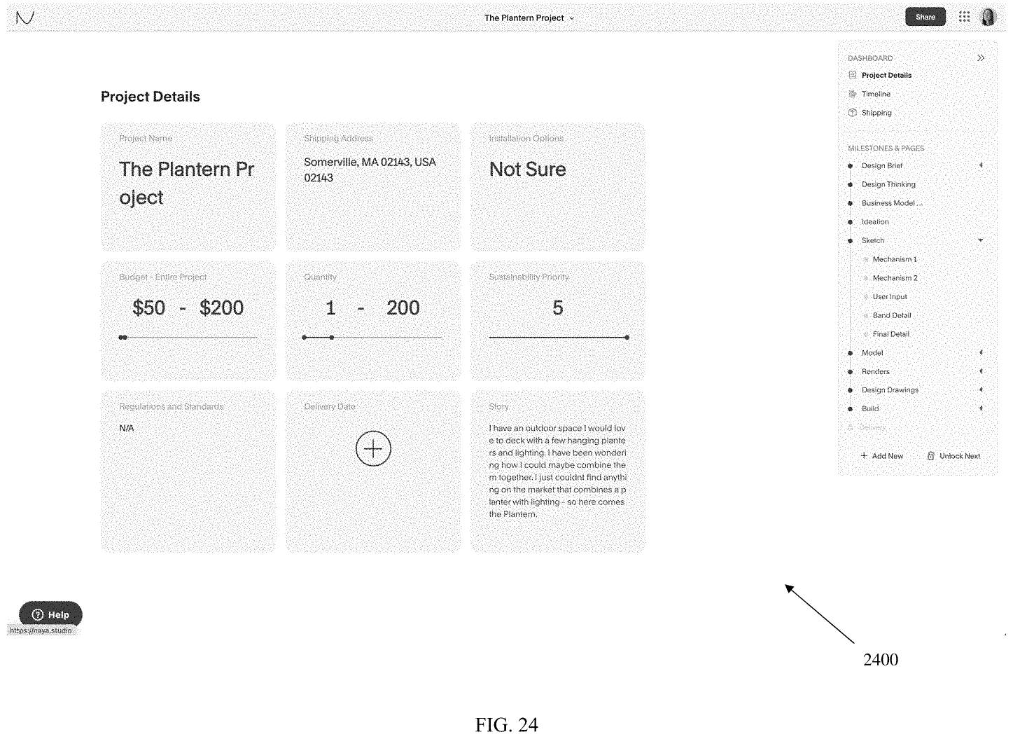

FIG. 24 is an illustration of one embodiment of a project details screen for use with a platform for designing, fabricating, and delivering custom articles of manufacture. As shown in FIG. 24, the project details screen 2400 may display a summary of various characteristics of the project, and may allow users a relatively quick option for modifying various aspects of the project.

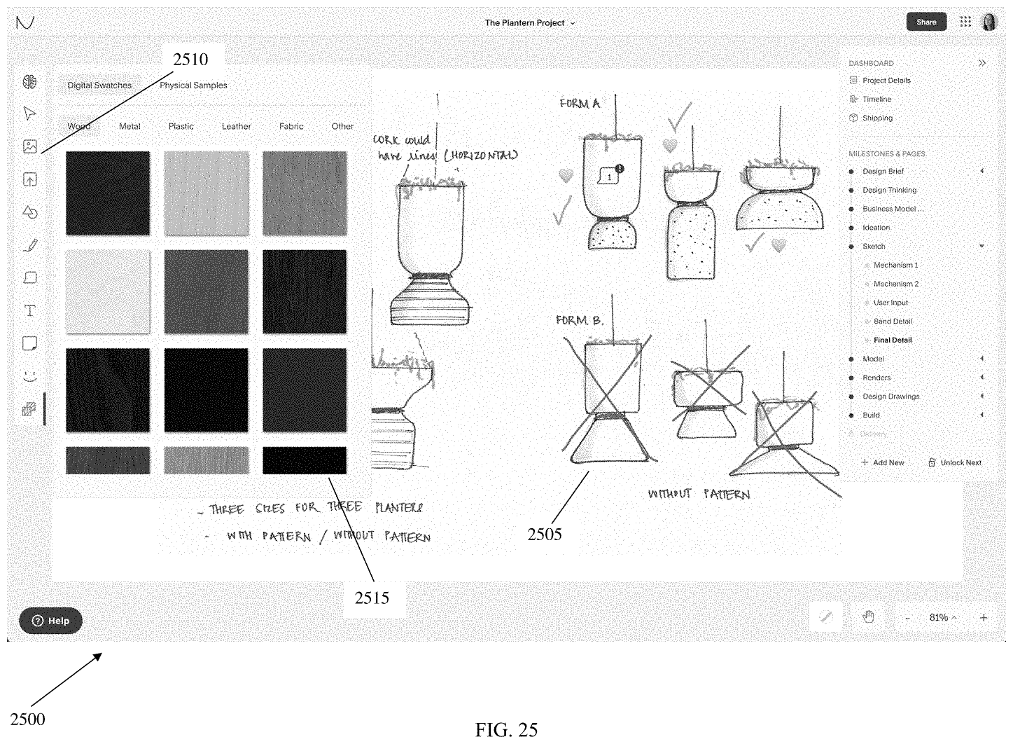

FIG. 25 is an illustration of one embodiment of a sketch input screen for use with a platform for designing, fabricating, and delivering custom articles of manufacture. As shown in FIG. 25, the sketch input screen 2500 may comprise a blank area that has been filled in 2505 and a set of drawing tools 2510, such that the user may use the drawing tools 2510 to draw in the blank area that has been filled in 2505 to represent their design idea. Further, users may mark up the blank area that has been filled in 2505 to convey to other users ideas about how to design the article of manufacture. The user may also be given the ability to assign different swatches or textures 2515 to the design.

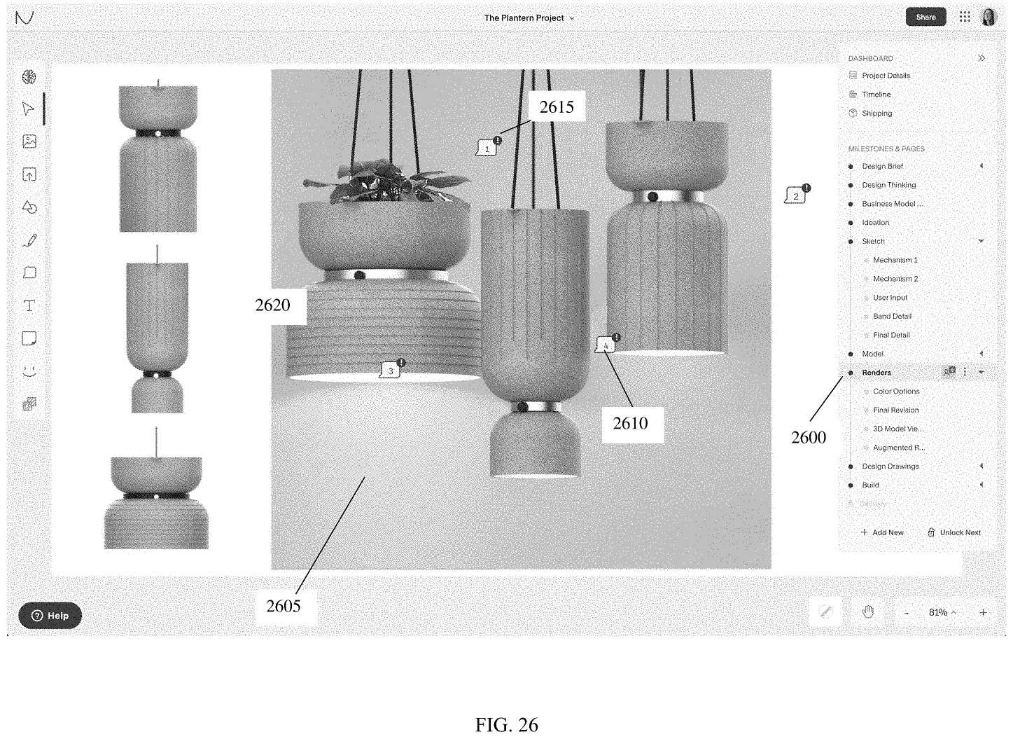

FIG. 26 is an illustration of one embodiment of a render input screen for use with a platform for designing, fabricating, and delivering custom articles of manufacture. As shown in FIG. 26, the render input screen 2600 may comprise a project area 2605 that displays a representation of the rendering of the article of manufacture. The render may also users to attach comments 2610, 2615, 2620 to sections of the project area 2605 to convey messages to other users.

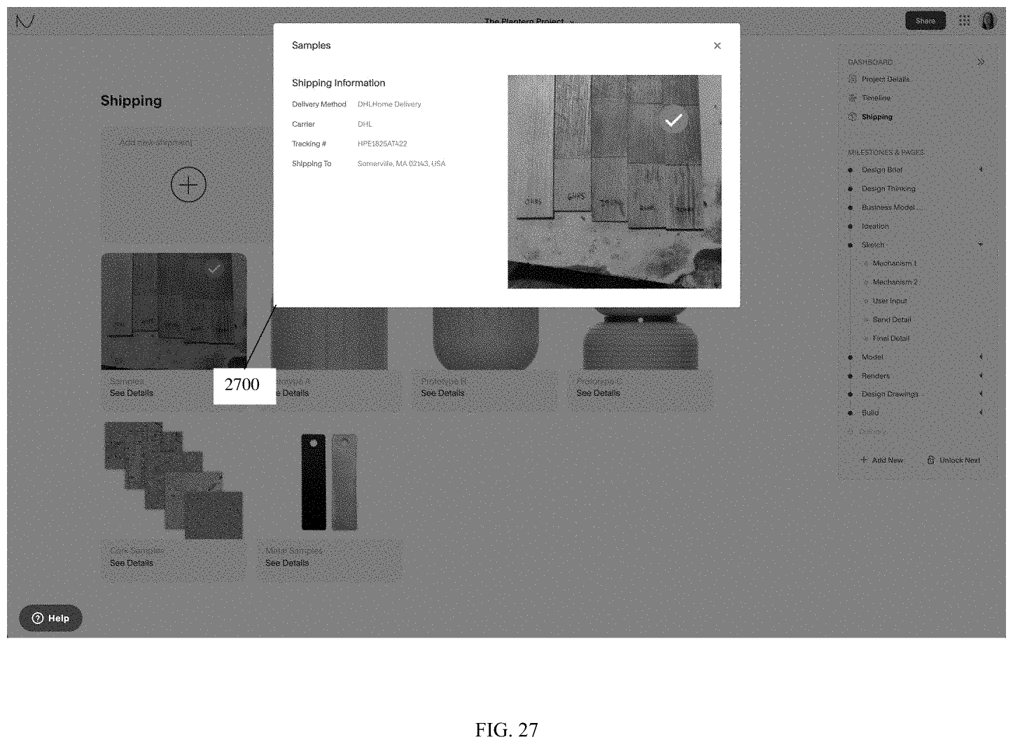

FIG. 27 is an illustration of one embodiment of a shipping information screen for use with a platform for designing, fabricating, and delivering custom articles of manufacture. As shown in FIG. 27, the shipping information screen 2700 may display various shipping information, including delivery method, carrier, tracking information, and delivery location.

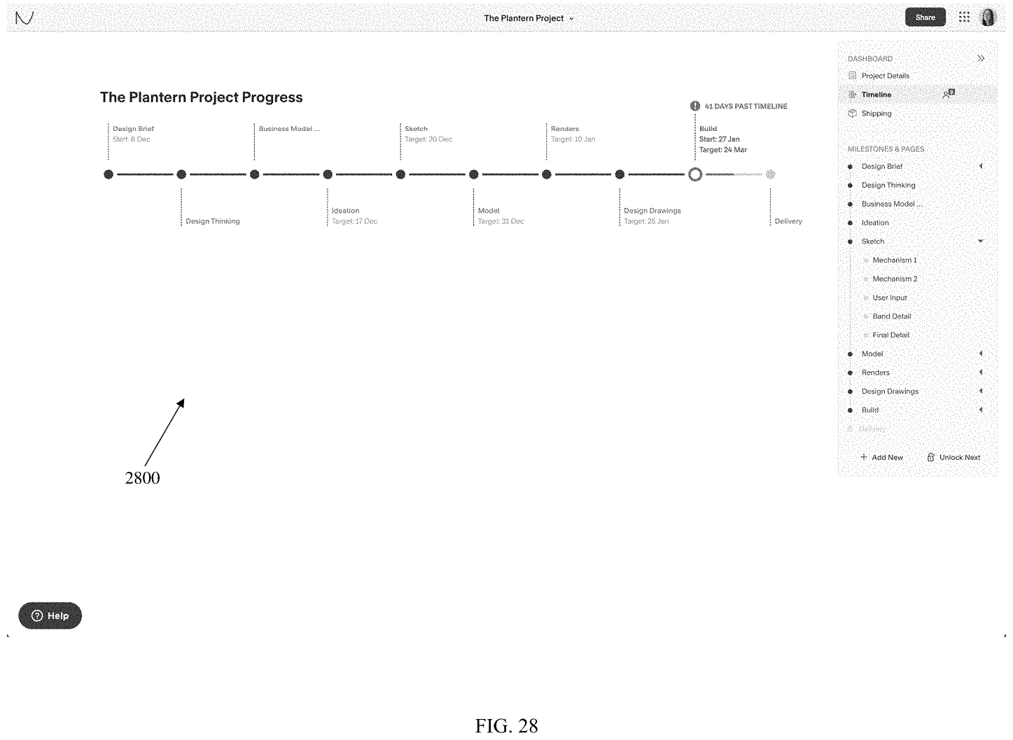

FIG. 28 is an illustration of one embodiment of a project progress screen for use with a platform for designing, fabricating, and delivering custom articles of manufacture. As shown in FIG. 28, the project progress screen 2800 may allow users to see at a glance where in the process the project currently is, and may provide various target dates regarding milestone events.

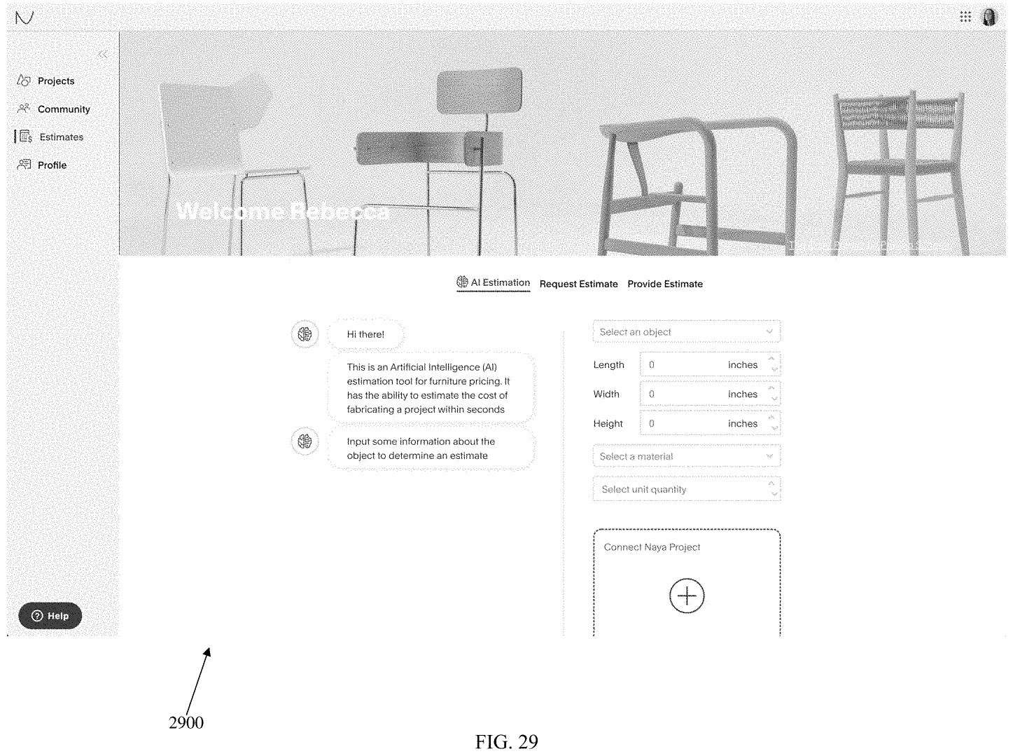

FIG. 29 is an illustration of one embodiment of a project estimation screen for use with a platform for designing, fabricating, and delivering custom articles of manufacture. As shown in FIG. 29, the project estimation screen 2900 may allow the user to input information relating to the project in order to allow an artificial intelligence module to generate an estimate for the cost of completing the project. In a preferred embodiment, the artificial intelligence module is able to learn by analyzing past projects, identify characteristics of the projects, and associate costs therewith.

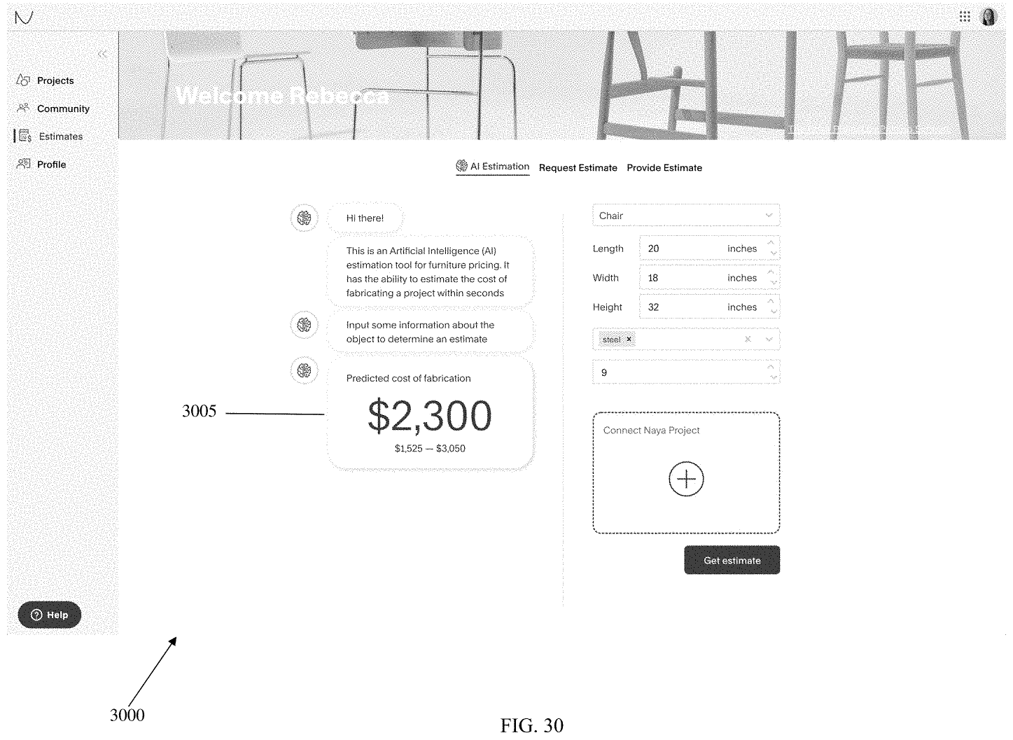

FIG. 30 is an illustration of one embodiment of a project estimation screen for use with a platform for designing, fabricating, and delivering custom articles of manufacture. As shown in FIG. 30, the project estimation screen 3000 may allow the user to input information relating to the project in order to allow an artificial intelligence module to generate an estimate for the cost of completing the project 3005.

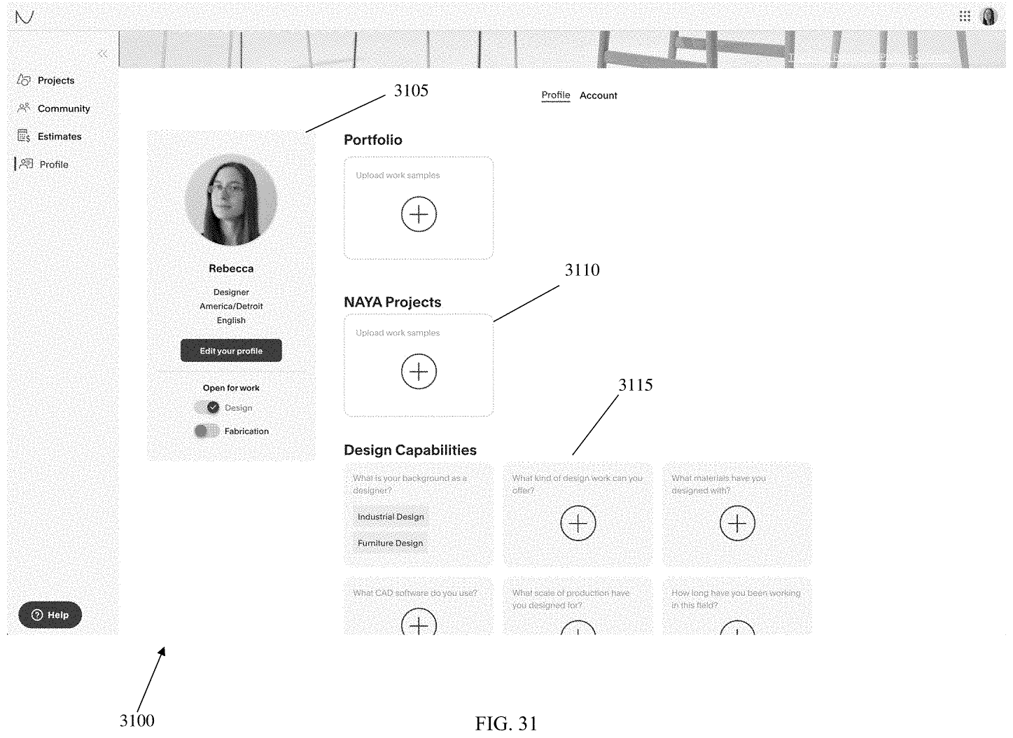

FIG. 31 is an illustration of one embodiment of a designer profile for use with a platform for designing, fabricating, and delivering custom articles of manufacture. As shown in FIG. 31, the designer profile 3100 may comprise a portfolio 3105, platform projects 3110, and design capabilities 3115. The information contained within the designer profile 3100 may be used to match the designer with specific projects and other users.

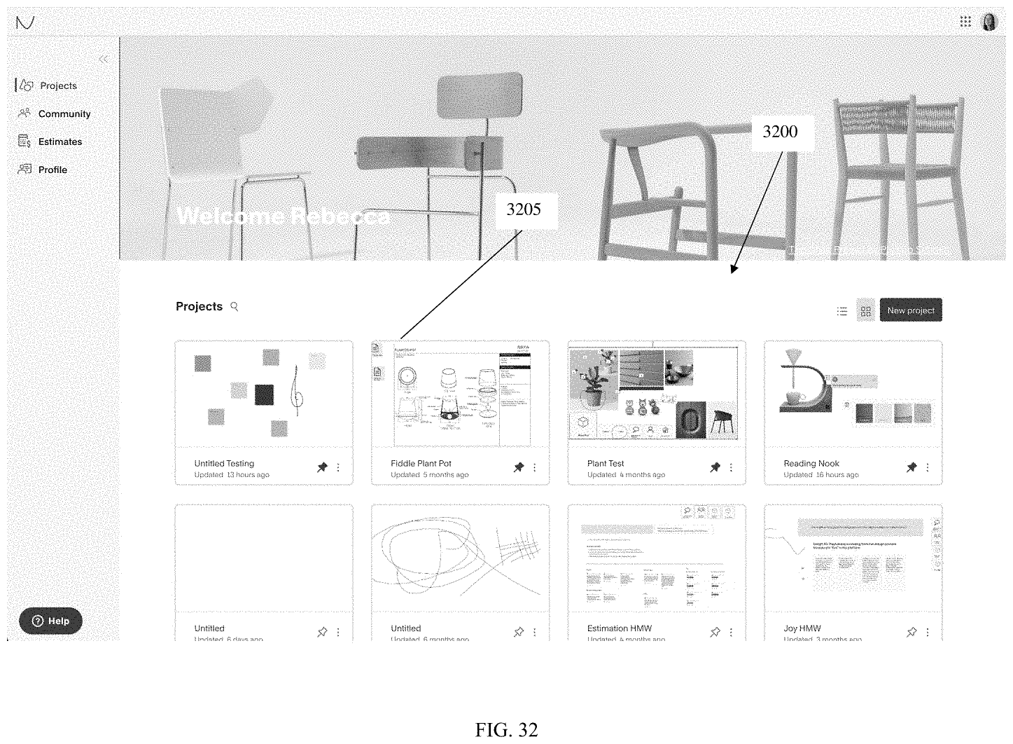

FIG. 32 is an illustration of one embodiment of a project management screen for use with a platform for designing, fabricating, and delivering custom articles of manufacture. As shown in FIG. 32, the project management screen 3200 may present the various projects that a designer is working on in a tile format 3205.

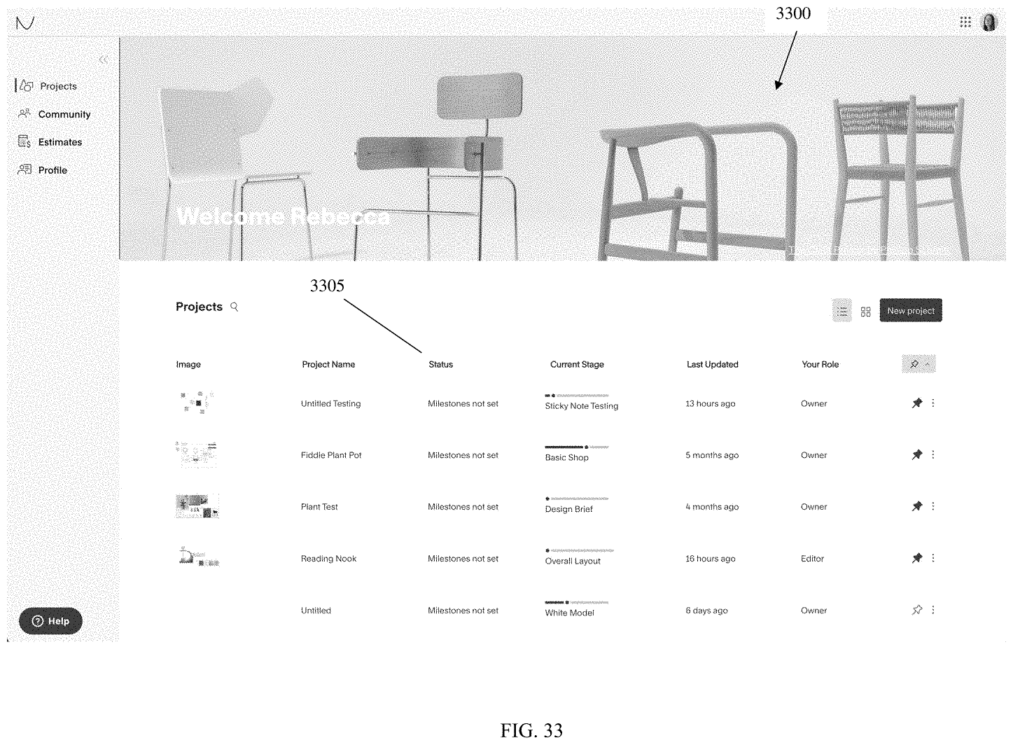

FIG. 33 is an illustration of one embodiment of a project management screen for use with a platform for designing, fabricating, and delivering custom articles of manufacture. As shown in FIG. 33, the project management screen 3300 may present the various projects that a designer is working on in a list and detail format 3305.

In some embodiments, the platform may be used in substantially any industrial context to facilitate the design and fabrication of physical goods and products based on its users specific and unique needs. Some industries include AI, Design, Industrial Design, Furniture, Manufacturing, Fabrication, Digital Design, Digital Fabrication, E-commerce, and Marketplace.

In some embodiments, the platform may be run on or communicate with a server. The server may be configured to maintain a database of consultants comprising designers, quality assurance specialists, fabricators, shippers, deliverers, and installers. The server may store information about each consultant and apply matchmaking algorithms to assign particular consultants to specific projects based on the methods described herein above.

In one embodiment, the platform may be accessible from a user's computer through an online portal. In some embodiments, the platform may be a downloadable software program.

In some embodiments, individuals may interact with the platform in different ways depending on their roles with respect to projects.

The disclosure presented herein above may be practiced by the use of computers, servers, databases, and other electronic devices.

In view of the exemplary systems described herein, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers.

Those of ordinary skill in the relevant art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component,” “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server may be a component. One or more components may reside within a process and/or thread of execution and a component may be localized on one computer and/or distributed between two or more computers.

Various embodiments presented in terms of systems may comprise a number of components, modules, and the like. It is to be understood and appreciated that the various systems may include additional components, modules, etc. and/or may not include all of the components, modules, etc. discussed in connection with the figures. A combination of these approaches may also be used.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those of ordinary skill in the art that various modifications and variations may be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method of designing, fabricating, and shipping an article of manufacture, comprising the steps:
providing an electronic platform;
prompting a user to provide one or more design characteristics of said article of manufacture on said electronic platform;
assigning a designer to generate a design of said article of manufacture based on said one or more design characteristics provided by said user;
assigning a consultant to modify said design to improve a potential fabrication process of said design;
assigning a fabricator; and
fabricating said article of manufacture by said fabricator, such that one or more fabricated articles of manufacture is created.

2. The method of designing, fabricating, and shipping an article of manufacture of claim 1, wherein said one or more design characteristics comprise a design brief, a sketch, a budget, dimensions, and one or more comments to generate a design brief of said article of manufacture on said electronic platform.

3. The method of designing, fabricating, and shipping an article of manufacture of claim 2, wherein said design brief allows said user to enter information relating to where said article of manufacture is intended to be placed, what said article of manufacture will be, for what said article of manufacture will be used, and how many copies of said article of manufacture is desired by said user.

4. The method of designing, fabricating, and shipping an article of manufacture of claim 3, wherein said sketch allows said user to provide one or more impressions of what said article of manufacture will look like when completed.

5. The method of designing, fabricating, and shipping an article of manufacture of claim 4, wherein said one or more impressions comprise at least one of one or more existing constructs, one or more free-hand sketches, one or more marked up illustrations, and combinations thereof.

6. The method of designing, fabricating, and shipping an article of manufacture of claim 4, wherein said budget comprises one or more monetary figures.

7. The method of designing, fabricating, and shipping an article of manufacture of claim 6, wherein said dimensions comprise a length, a width, and a height of said article of manufacture.

8. The method of designing, fabricating, and shipping an article of manufacture of claim 2, wherein said one or more comments comprise guidance as to one or more desired features of said article of manufacture.

9. The method of designing, fabricating, and shipping an article of manufacture of claim 1, wherein said designer is assigned by comparing said one or more design characteristics of said article of manufacture to one or more attributes of said designer to determine compatibility.

10. The method of designing, fabricating, and shipping an article of manufacture of claim 1, wherein said consultant is assigned by comparing said design with one or more attributes of said consultant to determine compatibility.

11. The method of designing, fabricating, and shipping an article of manufacture of claim 10, further comprising the step:
improving said design of said article of manufacturer from a fabrication standpoint by said consultant.

12. The method of designing, fabricating, and shipping an article of manufacture of claim 1, wherein said fabricator is assigned by comparing said design with one or more attributes of said fabricator to determine compatibility.

13. The method of designing, fabricating, and shipping an article of manufacture of claim 1, further comprising the step:
assigning a deliverer;
wherein said deliverer is assigned by comparing said one or more fabricated articles of manufacture with one or more attributes of said deliverer to determine compatibility.

14. The method of designing, fabricating, and shipping an article of manufacture of claim 13, further comprising the step:
delivering said one or more fabricated articles of manufacture to said user by said deliverer.

15. An article of manufacture;
wherein said article of manufacture is designed pursuant the system and method of claim 1.

16. A method of designing, fabricating, and shipping an article of manufacture, comprising the steps:
providing an electronic platform;
prompting a user to provide a description said article of manufacture on a canvas on said electronic platform;
assigning a designer to generate a design of said article of manufacture based on said one or more design characteristics provided by said user;
wherein said designer is assigned by identifying one or more characteristics of said article of manufacture and comparing said characteristics with one or more attributes of said designer to determine compatibility;
generating said design of said article of manufacture by said designer based on said description provided by said user;
assigning a consultant to make fabrication suggestions about said design for the purpose of making the design to make the fabrication process more efficient;
wherein said consultant is assigned by comparing said design with one or more attributes of said consultant to determine compatibility;
improving said design from a fabrication standpoint;
assigning a fabricator;
wherein said fabricator is assigned by comparing said design with one or more attributes of said fabricator to determine compatibility;
fabricating said article of manufacture by said fabricator;
assigning a deliverer; and
delivering said fabricated article of manufacturer to said user.
